(19) United States
(12) Patent Application Publication
(10) Pub. No.: US 2015/0066765 A1
(43) Pub. Date: Mar. 5, 2015

(54) PAYMENT APPARATUS AND METHOD

(71) Applicant: IP PayOvation Pty Ltd, South Yarra, Victoria (AU)

(72) Inventors: Benjamin David Banks, Wellington Point (AU); Grant Ainsley Benvenuti, Bald Hills (AU)

(21) Appl. No.: 14/388,576

(22) PCT Filed: Mar. 28, 2013
(86) PCT No.: PCT/AU2013/000333

§ 371 Date: Sep. 26, 2014

(30) Foreign Application Priority Data
Mar. 30, 2012 (AU) 2012901281

(51) Int. Cl. G06Q 20/40; G06Q 20/38; G06K 19/06; G06Q 20/32

(52) U.S. Cl. CPC G06Q 20/40; G06Q 20/327; G06Q 20/322; G06Q 20/385; G06Q 20/40145; G06K 19/06056
USPC 705/44

(57) ABSTRACT

A method for performing a payment from a payer to a payee, wherein the method includes receiving a payment request for the payment, the payment request being generated in response to the payee requesting funds from the payer; generating a transaction code and payment details using the payment request, the transaction code being obtained by the payer; receiving the transaction code from the payer; and, in response to receiving the transaction code, providing at least some of the payment details to the payer including a payment amount and an indication of the payee, thereby allowing the payer to authorise the payment.

### BACKGROUND OF THE INVENTION

The present invention relates to methods and apparatus for performing a payment between a payer and a payee.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Customers are currently presented with a range of available options for making payments to merchants or individuals. Traditional cash payments are increasingly being replaced with electronic payments, including online payments via the Internet.

Even cash payments may involve some form of electronic transaction, particularly where the cash used to make the payment is supplied from an automated teller machine (ATM). A typical ATM transaction commences with verification of a user's identity, usually by the user swiping a card and entering a Personal Identification Number, followed by the user requesting an amount of funds to be dispensed as cash. The ATM will then communicate with the user's bank to receive approval that the transaction can proceed (i.e. the requested amount of funds are available to be withdrawn from the user's account). Once the transaction is approved the requested amount of funds and any applicable surcharge amount will be transferred from the user's bank to the ATM owner's bank, and the requested amount of cash will be dispensed from the ATM.

However, payments with cash supplied from an ATM have their own associated problems. For example, the user may be need to pay high ATM surcharges if the ATM owner's bank is not part of the user's bank's ATM network. Daily withdrawal limits are often imposed on ATM transactions, which can prevent cash from being used to make large payments. In any event, carrying large amounts of cash can be a risky activity for a user, as cash can be prone to theft or loss. Importantly, cash payments require the payer and payee to physically meet to hand over cash, which tends to limit the usefulness of this payment type.

Electronic funds transfer (EFT) allows electronic transactions between accounts and hence provides flexibility over cash payments in that payments can be made without physical presence. A merchant or individual requiring payment from a customer provides the customer with information identifying a target bank account into which funds are to be transferred, and usually a customer reference to allow the payment to be reconciled. This information can be provided on an invoice for a purchase, or may simply be provided in an ad hoc manner (e.g. when one individual agrees to transfer an amount of funds to another individual).

In any event, the customer can then use Internet banking to request that the funds are transferred to the identified target bank account. The customer enters the target bank account information, approves the payment amount and receives notification that the amount will be transferred in due course.

However, the requirement for the customer to enter the target bank account information, usually a long string of numbers that hold no meaning for the customer, allows for human error. There is typically no verification that the target bank account information has been entered correctly or that the funds will be transferred to the correct recipient, since the recipient details are not provided to the customer with notification of the transfer. The recipient only receives notification of the payment when the funds are actually received in the recipient's account. This can be up to 4-5 days after the customer's request in some cases. Reconciliation of payments can also be made difficult if the customer fails to enter a meaningful customer reference.

In view of the above difficulties, EFT payments are usually considered unsuitable for online purchases, since goods can not be dispatched until payment can be confirmed by funds being received in the recipient's account.

More advanced online payment systems have seen increasing adoption since these allow consumers to more conveniently make payments via the Internet. One example of an online payment system is BPAY which is widely used in Australia. A merchant typically needs to register with the provider of the online payment system before the merchant can accept payments through the system. The merchant will then be allocated a biller code which the merchant must then include on a bill along with a customer reference number.

A customer receiving such a bill and wishing to make a payment may do so using Internet banking (or alternatively phone banking, although this will not be considered here). In particular, the customer logs in to their Internet banking account including supplying verification information as required by the customer's bank, after which the customer enters the biller code and customer reference number along with confirmation of the payment amount and the customer's account from which the funds are to be deducted. The customer's bank will then transfer the funds to the biller's bank (usually on the next business day as part of a batch process), after which details of the transfer will be sent to the online payment system provider for subsequent sending to the registered biller.

Although these types of online payment systems are convenient for use in paying bills, there are still several pitfalls. The customer reference numbers are typically long strings of numbers which must be manually entered by the customer, and there is usually no means for verifying the correctness of the customer reference numbers during the payment process, so a human error may result in an incorrect payment being made. The merchant will not be notified of the payment being successfully made, and cannot be certain of success until the transferred funds enter the biller's bank account in due course. This can make such online payment systems unsuitable for online purchases when goods must be dispatched, Fees charged by the online payment system provider can also be costly to merchants, and furthermore, since only registered merchants can issue bills, this practically limits the applicability of the online payment system such that only businesses can receive payments, and not individuals.

Online credit and debit card transactions have become an increasingly common mechanism for making online purchases. Typically, a customer will visit a merchant's website to select goods or services for purchase and after confirming their selection, the customer will be presented with a secure payment page on the merchant's website. The customer will then enter card information on the payment page.

This triggers an authorisation process where an authorisation request is ultimately transferred from the merchant to the merchant's bank (“acquiring bank”) and then to the customer's bank (“issuing bank”) via the credit/debit card company, and an authorisation response is then propagated back to the merchant. This authorisation process will usually be on the order of a few seconds or less and after successful authorisation the merchant will be in a position to consider the authorised payment complete and can arrange delivery of the goods/services.

The actual transfer of funds associated with the authorised payment will occur separately in an interchange of funds between the customer's bank and the merchant's bank. An interchange fee is usually payable by the merchant. This process may take several days.

Although a number of security measures have been applied to online credit and debit card payments over the years, a major security risk exists in that if the customer's card is stolen or lost anyone in possession of the card can make a payment. Another security concern is that, since the card details are entered via the merchant's website, the merchant may come into possession of the card details if the merchant's security is breached the card details may be exposed to potential misuse. In addition, only a small number of credit card companies exist and these companies therefore have significant control over the card payment market and demand high interchange fees, which are typically passed on to merchants and in turn to customers through increased prices.

Some third-party companies have established themselves as “payment gateways” by offering access to one or more online payment systems. Sometimes these third party companies may actually operate as an intermediate recipient of funds as these are transferred from the payer to the payee. This can help to minimise or eliminate the need for the payee and/or payer to have relationships with the actual banks, card companies and the like, and allow greater flexibility in the types of payments than can be accepted or made. However, these third party companies will typically charge their own fees for the transactions, which can be substantial.

US2010/0174626 relates to a method of processing payment authorisation requests for payment transactions to be conducted via a data communications network on behalf of online merchants. The payment authorisation requests are conducted as a result of orders by financial instrument holders via a plurality of different online merchant systems, each of said online merchants having an online merchant identity. The method is conducted by a trusted central intermediary system which is configured to transmit payment authorisation requests to each of a plurality of different online merchant Internet Payment Service Provider (IPSP) systems. In some embodiments, a user may select a payment method on a per transaction basis, while removing the requirement for the user to provide payment details to individual online merchant systems or to their merchant IPSP systems by having the user submit their respective payment details to a separate, trusted entity.

Thus, US2010/0174626 may be considered to relate to conventional “e-wallet” technologies, in that an interface is provided for coordinating online payment transactions that are in turn carried out by IPSPs. It is also noted that this document generally focuses on the use of card schemes and thus will be subject to their limitations as noted above.

US2007/0073629 discloses an automated payment system and clearinghouse for effecting payment on online transactions without having to divulge sensitive financial information to a merchant. The payment system and clearinghouse provides a vehicle to perform e-commerce transactions worldwide independently of the customer and merchant locations. This allows banks to offer their clients a way to pay for internet purchases without the need to use a credit card or to divulge credit-card information or bank account information.

It is noted that operation of the system of US2007/0073629 requires the customer to separately supply a transaction ID and the currency amount for the transaction to their bank to allow the payment to be completed. Furthermore, this system requires the clearinghouse to receive and hold transferred funds before these are released to the merchant, effectively introducing an additional transaction before funds are successfully transferred.

In view of the above, it will be appreciated that there are numerous shortcomings associated with existing payment systems.

### SUMMARY OF THE PRESENT INVENTION

In a broad form the present invention seeks to provide a method for performing a payment from a payer to a payee, wherein the method includes:
a) receiving a payment request for the payment, the payment request being generated in response to the payee requesting funds from the payer;
b) generating a transaction code and payment details using the payment request, the transaction code being obtained by the payer;
c) receiving the transaction code from the payer; and,
d) in response to receiving the transaction code, providing at least some of the payment details to the payer including a payment amount and an indication of the payee, thereby allowing the payer to authorise the payment.

Typically the method includes receiving the payment request from at least one of:
a) the payee; and,
b) a financial institution of the payee.

Typically the method includes providing the transaction code to at least one of:
a) the payee;
b) the financial institution of the payee;
c) the payer; and,
d) a financial institution of the payer.

Typically the method includes receiving the transaction code from at least one of:
a) the payer; and,
b) the financial institution of the payer.

Typically the method includes:
a) receiving an authorisation indication, the authorisation indication being generated in response to authorisation of the payment by the payer; and,
b) in response to the authorisation indication, causing the funds to be transferred from the payer to the payee to thereby perform the payment.

Typically the method includes causing the funds to be transferred from the payer to the payee using registered account details for the payer and the payee.

Typically the method includes providing a notification of results of the payment to at least one of:
a) the payee;
b) the financial institution of the payee;
c) the payer; and,
d) the financial institution of the payer.

Typically the method includes:
a) receiving the transaction code from the financial institution of the payer; and,
b) providing the payment details to the financial institution of the payer, thereby allowing the payer to authorise the payment via the financial institution of the payer.

Typically the method includes screening, for an indication of fraud, at least one of:
a) the payment request;
b) the transaction code; and,
c) the payment details.

A method according to any one of claims 1 to 9, wherein the method includes verifying the transaction code before providing the at least some of the payment details.

Typically the payment request includes payment request parameters supplied by the payee, at least some of the payment details being generated using the payment request parameters.

Typically the payment request parameters include at least one of:
a) the payment amount;
b) the indication of the payee;
c) identification of the payee's account into which the payment is to be made;
d) a payee reference for the payment;
e) conditions on how the payment can be made; and,
f) details of products associated with the payment.

Typically the conditions include at least one of:
a) whether the payment can be made in parts;
b) whether the payment can be overpaid;
c) a duration of time within which payment must be made; and,
d) whether the payment is a recurring payment.

Typically the transaction code includes a string of a plurality of alphanumeric characters.

Typically the transaction code is generated using a base 36 numeral system.

Typically at least some predetermined character positions within the transaction code are used to encode information regarding at least one of the payee and the payment.

Typically the transaction code is obtained by a plurality of payers, and the method includes:
a) receiving the transaction code from each of the plurality of payers;
b) providing the at least some of the payment details to the plurality of payers; and,
c) receiving authorisation for a respective portion of the payment from each of the plurality of payers, such that the total amount of the portions is equal to or greater than the amount of the payment requested by the payee.

Typically the method includes communicating with the payer via the financial institution of the payer.

In another broad form the present invention seeks to provide a method for providing a transaction code for use in performing a payment from a payer to a payee, wherein the method includes a financial institution of the payee:
a) receiving a payment request for the payment from the payee, the payment request being generated in response to the payee requesting funds from the payer;
b) providing the payment request to a payment service provider to allow a transaction code and payment details to be generated using the payment request;
c) receiving the transaction code from the payment service provider; and,
d) providing the transaction code to the payee.

Typically the method includes the financial institution of the payee screening the payment request for an indication of fraud.

Typically the method includes the financial institution of the payee:
a) obtaining an authentication information from the payee; and,
b) verifying the authentication information before providing the payment request to the payment service provider.

In another broad form the present invention seeks to provide a method for receiving authorisation for use in performing a payment from a payer to a payee, wherein the method includes a financial institution of the payer:
a) receiving a transaction code from the payer, the transaction code being associated with payment details for the payment;
b) providing the transaction code to a payment service provider;
c) receiving at least some of the payment details associated with the transaction code from the payment service provider, the at least some of the payment details including a payment amount and an indication of the payee;
d) providing the at least some of the payment details to the payer; and,
e) receiving an authorisation from the payer to make the payment in accordance with the at least some of the payment details.

Typically the method includes the financial institution of the payer screening the at least some of the payment details for an indication of fraud.

Typically the method includes the financial institution of the payer:
a) obtaining authentication information from the payer; and,
b) verifying the authentication information.

Typically the method includes the financial institution of the payer:
a) in response to authorisation of the payment by the payer, generating an authorisation indication; and,
b) providing the authorisation indication to the payment service provider to thereby allow the payment service provider to cause the funds to be transferred from the payer to the payee to thereby perform the payment.

Typically the method includes the financial institution of the payer, in response to the receiving the authorisation, causing the funds to be transferred from the payer to the payee to thereby perform the payment.

In another broad form the present invention seeks to provide a method for performing a payment from a payer to a payee, wherein the method includes, at a payer station operated by the payer:
a) obtaining a transaction code, the transaction code being associated with payment details for the payment;
b) providing the transaction code to a payment service provider;
c) receiving at least some of the payment details associated with the transaction code from the payment service provider, the at least some of the payment details including a payment amount and an indication of the payee;
d) displaying the at least some of the payment details;
e) receiving an authorisation from the payer to make the payment in accordance with the at least some of the payment details; and,
f) generating an authorisation indication for causing the funds to be transferred from the payer to the payee to thereby perform the payment.

Typically the authorisation indication is provided to at least one of:
a) the payment service provider; and,
b) a financial institution of the payer.

Typically the method includes the payer station receiving authentication information for allowing an identity of the payer to be verified before the authorisation.

Typically the authentication information is provided to at least one of:
a) the payment service provider; and,
b) a financial institution of the payer.

Typically the transaction code is obtained by the payer station using at least one of:
a) short messaging service (SMS);
b) instant messaging (IM)
c) email;
d) dual-tone multi-frequency signalling (DTMF)
e) wireless communication;
f) near field communication (NFC);
g) a barcode;
h) a QR code; and,
i) manual input by the payer.

In another broad form the present invention seeks to provide a method for performing a payment from a payer operating a payer station to a payee operating a payee station, wherein the method includes:
a) at the payee station, generating a payment request for the payment
b) at a payment processing station,
   i) receiving the payment request; and,
   ii) generating a transaction code and payment details using the payment request;
c) at the payer station, obtaining the transaction code;
d) at the payment processing station:
   i) receiving the transaction code from the payer station; and,
   ii) providing at least some of the payment details to the payer station including a payment amount and an indication of the payee; and,
e) at the payer station:
   i) receiving the at least some of the payment details; and,
   ii) obtaining authorisation from the payer to make the payment in accordance with the at least some of the payment details.

Typically the method includes:
a) at the payer station:
   i) in response to the authorisation from the payer, generating an authorisation indication; and,
   ii) providing the authorisation indication to the payment processing station; and,
b) at the payment processing station:
   i) receiving the authorisation indication; and,
   ii) in response to the authorisation indication, causing the funds to be transferred from the payer to the payee to thereby perform the payment.

Typically the method includes the payment processing station receiving the payment request from at least one of:
a) the payee station; and,
b) a payee financial institution station.

Typically the method includes the payment processing station providing the transaction code to at least one of:
a) the payee station;
b) the payee financial institution station;
c) the payer station; and,
d) a payer financial institution.

Typically the method includes the payment processing station receiving the transaction code from at least one of:
a) the payer station; and,
b) the payer financial institution station.

Typically the method includes, at a payer financial institution station:
a) receiving an authorisation indication from the payer station; and,
b) providing the authorisation indication to the payment processing station to thereby cause the funds to be transferred from the payer to the payee.

Typically the method further includes having the payment request screened for indications of fraud by at least one of:
a) the payee station;
b) the payee financial institution; and,
c) the payment processing station.

Typically the method further includes having at least some of the payment details screened for indications of fraud by at least one of:
a) the payer station;
b) the payer financial institution; and,
c) the payment processing station.

In another broad form the present invention seeks to provide a method for performing a payment from a payer operating a payer station to a payee operating a payee station, wherein the method includes:
a) at the payee station:
   i) generating a payment request for the payment; and,
   ii) providing the payment request to a payee financial institution
b) at the payee financial institution station:
   i) receiving the payment request; and,
   ii) providing the payment request to a payment processing station;
c) at the payment processing station,
   i) receiving the payment request; and,
   ii) generating a transaction code and payment details using the payment request;
d) at the payer station:
   i) obtaining the transaction code; and,
   ii) providing the transaction code to the payer financial institution
e) at the payer financial institution station:
   i) receiving the transaction code; and,
   ii) providing the transaction code to a payment processing station;
f) at the payment processing station:
   i) receiving the transaction code; and,
   ii) providing at least some of the payment details to the payer financial institution including a payment amount and an indication of the payee;
g) at the payer financial institution station:
   i) receiving the at least some of the payment details; and,
   ii) providing the at least some of the payment details to the payer;
h) at the payer station:
   i) receiving the at least some of the payment details; and,
   ii) obtaining authorisation from the payer to make the payment in accordance with the at least some of the payment details; and,
i) in response to the authorisation, causing funds to be transferred from the payer to the payee to thereby perform the payment.

In another broad form the present invention seeks to provide a method for performing a payment from a payer operating a payer station to a payee operating a payee station, wherein the method includes:
a) at the payee station, generating a payment request for the payment;
b) at the payer station:
   i) obtaining a transaction code and payment details, the transaction code and payment details being generated using the payment request;
   ii) obtaining authentication information;
   iii) obtaining authorisation from the payer to make the payment in accordance with the payment details; and,
   iv) generating an authorisation indication and authentication information; and,
c) at a payment processing station, in response to the authorisation indication and the authentication information, causing funds to be transferred from the payer to the payee to thereby perform the payment.

Typically the method further includes, at the payment processing station:
a) receiving the payment request from the payee station; and,
b) generating the transaction code and the payment details using the payment request.

Alternatively the method further includes, at the payee station, generating the transaction code and the payment details using the payment request.

Typically the payment request includes payment request parameters supplied by the payee, at least some of the payment details being generated using the payment request parameters.

Typically the payment request parameters include at least one of:
a) identification of the payee's account into which payment is to be made;
b) a payee reference for the payment;
c) an amount of funds to be paid;
d) conditions on how the payment can be made; and,
e) details of products associated with the payment.

Typically the conditions include at least one of:
a) whether the payment can be made in parts;
b) whether the payment can be overpaid;
c) a duration of time within which payment must be made; and,
d) whether the payment is a recurring payment.

Typically the method further includes:
a) at the payment processing station, associating payment details with the transaction code; and,
b) at the payer station:
   i) obtaining the transaction code; and,
   ii) obtaining, from the payment processing station, payment details associated with the transaction code and displaying at least some of the payment details to the payer for authorisation.

Typically the transaction code includes a string of a plurality of alphanumeric characters.

Typically the transaction code is generated using a base 36 numeral system.

Typically at least some predetermined character positions within the transaction code are used to encode information regarding at least one of the payee and the payment.

Typically a receipt number is generated after a payment has been performed, the receipt number including the transaction code for the payment.

Typically the receipt number further includes an expandable portion of characters in addition to the characters of the transaction, the expandable portion being used in the event that a plurality of payments are made for the same transaction code.

Typically the method is used to perform a payment for an online purchase of products from the payee by the payer, the method further including, at the payee station:
a) receiving, from a payer using the payer station to access a payee website hosted by the payee station, a selection of products for purchase;
b) generating the payment request for payment for the products;
c) transferring the payment request to the payment processing station;
d) receiving confirmation from the payment processing station once payment has been performed; and,
e) arranging delivery of the products to the payer.

Typically the authentication information and authorisation indication are obtained by a financial institution station holding an account of the payer.

Typically the method further includes:
a) at the financial institution station, receiving the transaction code and the payment details;
b) at the payer station, communicating with the financial institution station to provide authentication information and to authorise the payment associated with the transaction code, in accordance with the payment details; and,
c) at the payment processing station, receiving an authorisation indication from the financial institution and transferring funds from the payer to the payee to thereby perform the payment.

Typically the method further includes embedding the transaction code into a barcode that is provided to the payer, the payer station obtaining the transaction code by scanning and decoding the barcode.

Typically the barcode is provided to the payer by at least one of:
a) printing the barcode onto an invoice;
b) displaying the barcode on the payee station;
c) displaying the barcode on the payer station; and,
d) printing the barcode onto an object.

Typically the payer operates a first payer station and a second payer station, the second payer station being a mobile computing device, the barcode being displayed on a display of the first payer station and being scanned and decoded by the second payer station such that the transaction code is obtained by the second payer, station.

Typically the payer operates a first payer station and a second payer station, the second payer station being a mobile computing device, the method further including:
a) at the second payer station, providing a one time password to the payer; and,
b) at the first payer station, having the payer input the one time password to thereby obtain at least some of the authentication information.

Typically the payer station is a mobile computing device that operates application software for allowing secure communications with the payment processing station.

Typically the method is used to perform a point of sale payment for a purchase of products from the payee by the payer, the method further including:
a) at the payee station:
   i) generating the payment request for payment for products selected by the payer for purchase; and,
   ii) providing the transaction code to the payer;
b) at the payer station:
   i) obtaining the transaction code;
   ii) obtaining authentication information and obtaining authorisation from the payer; and,
   iii) providing an authorisation indication and authentication information to the payment processing station; and,
c) at the payee station:
   i) receiving confirmation from the payment processing station once payment has been performed; and,
   ii) providing confirmation to the payer that the products have been paid for.

Typically the payment processing station provides the transaction code to the payer station.

Typically each of the payee and the payer are account holders holding at least one account with a financial institution and having respective account details registered with the payment processing station.

Typically the registration of an account holder's account includes:
a) at the payment processing station:
   i) receiving a pairing request from an account holder; and,
   ii) generating a pairing code and providing the pairing code to the account holder;
b) at the financial institution:
   i) receiving the pairing code;
   ii) communicating with the payment processing station to obtain verification of the pairing code; and,
   iii) providing the account holder's account details to the payment processing station; and,
c) at the payment processing station, storing the account details to thereby register the account.

Typically the method further includes having a plurality of payers make portions of the payment such that the total amount of the portions is equal to or greater than the amount of the payment requested by the payee.

Typically each of the plurality of payers operates a respective payer station, the method further including, at each payer station:
a) obtaining the transaction code and payment details;
b) receiving, from the payer, authorisation for making a specified portion of the payment associated with the transaction code;
c) transferring an authorisation indication to the payment processing station, to allow the payment processing station to cause funds to be transferred from the payer to the payee to thereby perform the portion of the payment; and,
d) receiving a receipt number for the portion of the payment.

Typically the payment processing station provides a notification to the payee once the amount of the payment requested by the payee has been collectively paid by the plurality of payers.

Typically the method further includes the payment processing station authenticating the payer's identity before causing the funds to be transferred.

Typically the authentication includes at least one of:
a) requiring entry of an authentication code by the payer at the payer station;
b) requiring that the payer station has a device identifier matching a registered device identifier; and,
c) requiring entry of a biometric identifier matching a registered biometric identifier.

In another broad form the present invention seeks to provide a method for performing a payment from a payer operating a payer station to a payee operating a payee station, wherein the method includes, at a payment processing station:
a) receiving, from the payee station, a payment request for the payment;
b) generating a transaction code and payment details using the payment request; and,
c) in response to an authorisation indication and authentication information generated by the payer station, causing funds to be transferred from the payer to the payee to thereby perform the payment.

In another broad form the present invention seeks to provide a method for performing a payment from a payer operating a payer station to a payee operating a payee station, wherein the method includes, at the payer station:
a) receiving a transaction code and payment details generated using a payment request, the payment request being generated by the payee station;
b) displaying the payment details;
c) in response to the displayed payment details, receiving authorisation and authentication information from the payer; and,
d) generating an authorisation indication and the authentication information for transfer to the payment processing station, to allow the payment processing station to cause funds to be transferred from the payer to the payee to thereby perform the payment.

In another broad form the present invention seeks to provide apparatus for performing a payment transaction from a payer to a payee, the apparatus including a payer station operated by the payer, a payee station operated by the payee, and a payment processing station operated by a payment service provider, wherein the apparatus is for:
a) at the payee station, generating a payment request for the payment;
b) at the payer station:
   i) obtaining a transaction code and payment details, the transaction code and payment details being generated using the payment request;
   ii) obtaining authentication information;
   iii) obtaining authorisation from the payer to make the payment in accordance with the payment details; and,
   iv) generating an authorisation indication and authentication information; and,
c) at a payment processing station, in response to the authorisation indication and the authentication information, causing funds to be transferred from the payer to the payee to thereby perform the payment.

Typically the payer station and payee station communicate with the payment processing station using a communications network.

Typically the apparatus is for performing a method as described above.

In another broad form the present invention seeks to provide apparatus for performing a payment from a payer operating a payer station to a payee operating a payee station, the apparatus including a payment processing station in communication with the payer station and the payee station, wherein the payment processing station is for:
a) receiving, from the payee station, a payment request for the payment;
b) generating a transaction code and payment details using the payment request; and,
c) in response to an authorisation indication of authorisation from the payer to make the payment associated with the transaction code and authentication information generated by the payer station, causing funds to be transferred from the payer to the payee to thereby perform the payment.

In another broad form the present invention seeks to provide apparatus for performing a payment from a payer to a payee, the apparatus including a payer station operated by the payer, a payee station operated by the payee, and a payment processing station operated by a payment service provider, wherein the payer station is for:
a) receiving a transaction code any payment details generated using a payment request, the payment request being generated by the payee station;
b) displaying the payment details;
c) in response to the displayed payment details, receiving authorisation and authentication information from the payer; and,
d) generating an authorisation indication and the authentication information for transfer to the payment processing station, to allow the payment processing station to cause funds to be transferred from the payer to the payee to thereby perform the payment.

### BRIEF DESCRIPTION OF THE DRAWINGS

An example of the present invention will now be described with reference to the accompanying drawings, in which:

FIG. 1 is a flow chart of an example of a method for performing a payment between a payer and a payee;

FIG. 2 is a schematic diagram of an example of a distributed computer architecture;

FIG. 3 is a schematic diagram of an example of a processing system;

FIG. 4 is a schematic diagram of an example of an end station;

FIGS. 5A to 5K are flow charts of an example of a method for performing a payment for an online purchase;

FIGS. 6A to 6C are flow charts of an example of a method for performing a payment in which the transaction code is obtained by the payer by scanning a barcode;

FIGS. 7A to 7C are flow charts of an example of a method for performing a payment for a point of sale purchase;

FIGS. 8A and 8B are flow charts of an example of a method for registering an account with the payment service provider;

FIG. 9 shows an example apparatus configuration for making a payment for an online purchase using internet banking;

FIG. 10 shows an example apparatus configuration for making a payment for an online purchase using the payment service provider's website;

FIG. 11 shows an example apparatus configuration for making a payment for an online purchase using a mobile device;

FIG. 12 shows an example apparatus configuration for making a payment from a payer to a payee;

FIG. 13 shows an example apparatus configuration for making a point of sale payment from a customer to a merchant;

FIG. 14 is a flow chart of an example of a method for performing a payment from a payer to a payee;

FIGS. 15A to 15C are flow charts of an example of a method for performing a payment, where the payee and the payer interface with respective financial institutions;

FIGS. 16A and 16B are flow charts of a further example of a method for providing a transaction code in response to a payment request, including screening of the payment request by the payee financial institution and a payment service provider; and,

FIGS. 17A and 17D are flow charts of a further example of a method for performing a payment in response to a transaction code being obtained, including screening of the payment by the payer financial institution and the payment service provider.

### DETAILED DESCRIPTION OF THE PREFERRED EMBODIMENTS

In broad terms, the present invention provides methods for allowing a payment to be made from a payer, such as a customer, to a payee, such as a merchant. The payment will generally be performed as an electronic transaction, with the payer operating a payer station and the payee operating a payee station. A payment processing station will generally be responsible for causing the transfer of funds. The payment processing station is typically operated by a payment service provider responsible for facilitating the payment.

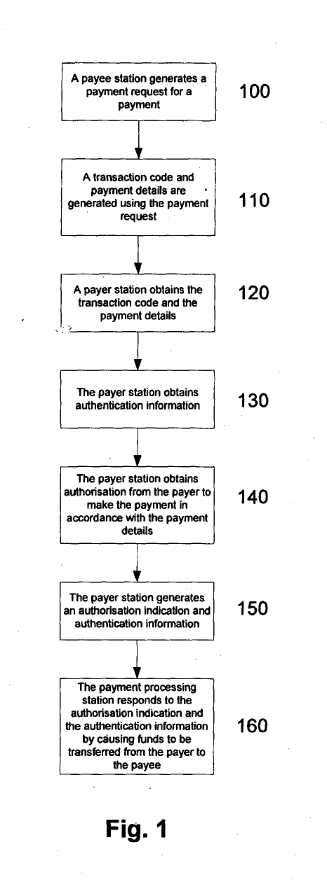

An example method for performing a payment will now be described with reference to the flowchart of FIG. 1.

The method is typically initiated by the payee, by having the payee station generate a payment request for a payment, as per step 100. As will be explained further, payment requests can be generated for many different types of payments desired by the payee. For example, the payee may be a merchant operating an online business, and the payment request may be generated in response to an online purchase of goods by a customer. In another example, the payment request may be generated as part of the preparation of an invoice for other goods or services, and such an invoice may allow payment after provision of the goods/services. The method may extend to payments between two individuals, and in these cases an individual desiring funds from another individual will generate a payment request.

The payment request can then be used to allow a transaction code and payment details to be generated, as shown at step 110.

The transaction code is generally used throughout the subsequent steps of the payment method as a reference for the payment transaction. It allows the payment to be identified consistently between the payer station, payee station, and payment processing station, and facilitates the transfer of any the payment details and any other information associated with the payment, to thereby allow the payment to be performed. The transaction code may be generated using generation algorithms which also allow information regarding the payment or payee to be embedded within the transaction code.

The payment details will generally include details to allow the payer to confirm that they wish to proceed with the payment. For example, the payment details may include an amount for the payment along with identification of the payee. The payment request may directly specify payment details such as the amount for payment. However, in some cases the payment request may only have a payee identification number, whereas the payer will usually wish to see alternative details for the payee, such as a name. Accordingly, such payment details may be generated along with the transaction code, for example based on account details for the payee which may be looked up on the basis of information supplied in the payment request.

Other payment request parameters may also be associated with the transaction code, and these may be supplied by the payee as part of the payment request, for example to allow them to be incorporated into the transaction code when it is generated. Examples of other payment request parameters will be expanded upon in due course.

In one example, the payee station may provide the payment request to the payment processing station, and the transaction code and payment details may subsequently be generated by the payment processing station. By having the payment processing station generate the transaction code and payment details, this ensures that transaction codes and payment details are generated in a consistent manner that is coordinated centrally by the payment service provider.

However, in alternative examples, the transaction code and payment details may be generated elsewhere. For instance, the payee station may locally generate the transaction code and payment details. In this case, the payee station will typically need to generate the transaction code in such a way that the different payee stations are unable to generate the same transaction codes. This may be achieved by generating the transaction codes so that a portion of each transaction code generated by a particular payee is unique to the payee.

In any event, once the transaction code and payment details have been generated, this can then be used to allow the payer to authorise the payment from the payer's account. Typically, the transaction code and payment, details will be obtained in some form by the payer station as shown at step 120. It will be appreciated that the transaction code and payment details can be obtained in a number of different ways.

In the example of a payment from a customer to a merchant for an online purchase, the transaction code may be transferred to the payer station operated by the customer via the merchant's website or via a separate website provided by the payment service provider.

In another example, the transaction code may be provided to the payer by embedding the transaction code into a barcode or QR code. In this case, the payer may use an image scanning functionality of the payer station to scan the barcode or QR code, and extract the transaction code from the barcode or QR code. It will be appreciated that QR codes are frequently used by embedding a uniform resource locator (URL) address into the QR code which can be accessed when the QR code is scanned. Accordingly, in an alternative example, the transaction code may be incorporated into a URL which is embedded into a QR code, and the transaction code may subsequently be extracted from the URL when embedded URL is determined by scanning the QR code.

Irrespective of how the transaction code is obtained at the payer station, ultimately the transaction code will be used as a reference to allow the payer to authorise the payment. Payment details (along with other optional payment request parameters) may be retrieved from the payment service provider by also using the transaction code as a reference, and may subsequently be displayed to the payer to allow the payer to confirm the details of the transaction before providing authorisation.

The payer station will then obtain authentication information at step 130, to thus authenticate the identity of the payer. This authentication can be obtained using any suitable authentication technique known in the art. For instance, authentication may involve the payer entering a username (or other identifier) and password, a personal identification number (PIN), the use of biometric security methods, the use of a one-time password (OTP) code issued to the payer, or the like. Irrespective of the technique, the authentication information can be used to confirm the identity of the payer.

Assuming the payer wishes to proceed with the payment, the payer station then obtains authorisation from the payer to make the payment at step 140. For example, this authorisation may involve the payer confirming that they wish to have the payment amount deducted from a nominated account.

The payer station will subsequently generate an authorisation indication and authentication information at step 150. In general, the payment will not be able to proceed unless the authorisation indication and authentication information are generated. At this point, the authorisation indication and authentication information are typically provided to either the payment processing system, or directly to the user's financial institution, allowing the payment to be authorised.

At this point, the payment processing station can proceed to perform the payment authorised by the payer. Accordingly, at step 160 the payment processing station responds to the indication of the authorisation by causing funds to be transferred from the payer to the payee.

This may occur by the payment processing station issuing a request to an electronic funds transfer switch to transfer of funds from the payer's account to the payees account. As part of such a request the payment processing system may provide account details and payment details to allow the switch to carry out the transfer. The payment processing station may be integrated with the switch, but the procedure will be similar nonetheless.

As will be discussed further below, it is not essential for the authorisation indication and authentication information to each flow directly from the payer station to the payment processing station in this method. For instance, authorisation and authentication may be handled separately by a financial institution by the payer accessing the financial institution's website, after which the financial institution provides confirmation to the payment processing station that the payment is to proceed. Nevertheless, it will generally be necessary for the payment to be authorised by the payer in some fashion and for the payer's identity to be authenticated before funds can be transferred, for security reasons.

After the payment transaction has been processed, notification of the success or otherwise of the transaction may be provided to the payer and payee. This may trigger further optional actions, such as the delivery of goods from the payee once successful payment has been confirmed.

The above method provides a number of benefits when compared to the prior art. Importantly, the use of the transaction code and payment details provides the payer with an ability to better confirm that the correct payment is about to be made. The payer can confirm the payment in accordance with the payment details as part of authorisation step, where the payment details can be obtained at the payer station. In contrast, conventional online payment systems typically place the burden on the user to ensure that payment details are entered correctly and there is usually no opportunity for the payer to confirm the payment details associated with the payment. Accordingly, this difference over conventional online payment systems helps to improve customer's confidence in the use of the payment method and helps to prevent incorrect payments from being made.

It will also be appreciated that the above method allows the payment transaction processing to be facilitated completely by an independent third party, namely the payment service provider, without the need for the payee to receive personal account details or the like from the payer. This is in contrast with existing online credit card payment systems and the like, and offers a significant improvement in the security of the payer's personal information.

The above discussed method is further in contrast with other conventional payment service provider offerings where funds are transferred through a third party as an intermediate step. In this present method a direct transfer of funds from the payer's account and the payee's account can take place without the need for funds to be received and disbursed by the payment service provider. However, a transaction fee can also be applied.

It will be appreciated that the payment method offers a simplified method of making payments compared to prior art techniques. A merchant or the like can initiate the payment method by generating the payment request, and a plurality of payment requests can be easily prepared and transferred to the payment processing station in a batch request, or automated process, for example.

The payee does not need to provide account details directly to the payer, and does not rely on the payer to manually enter account details correctly to allow the proper payment to be made. Furthermore, the payee does not need to be a merchant as such in order to have the ability to accept a payment using the payment method. These factors also help to also make the payment method more appropriate for ad hoc payments between individuals.

In one example, the method is performed at least in part using processing systems, such as suitably programmed computer systems. Each of the payer station and the payee station will typically include a respective processing system, which will generally have the capability to communicate with other processing systems via a communications network or the like. The processing systems may be configured to receive input commands and data from the respective user, and to display information to the respective user.

Examples of suitable processing system architectures will be expanded upon below, but in one example, the processing system of at least the payer station is provided in a desktop computer or a mobile computing device such as a smart phone, tablet computer, or the like, and functionalities of the payer station are provided by executing application software on the processing system. The use of a mobile computing device in particular can greatly enhance the flexibility of the payment system, as will be described in further detail below.

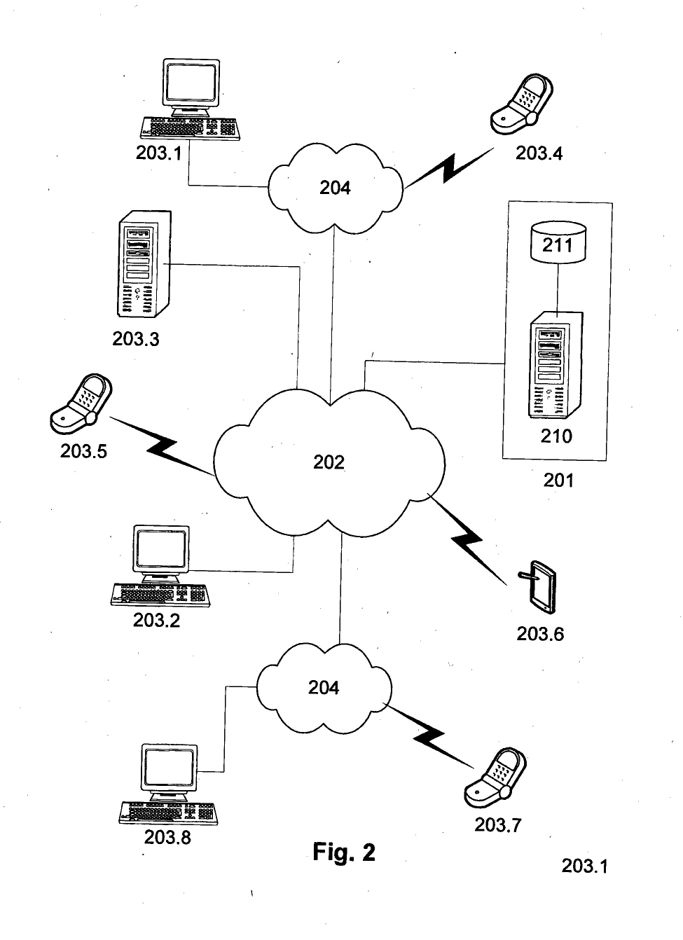

The method may desirably be performed by processing systems operating as part of a distributed architecture. An example of a distributed architecture will now be described with reference to FIG. 2.

In this example, a base station 201, such as the payment processing station discussed above, is coupled via a communications network, such as the Internet 202, and/or a number of local area networks (LANs) 204, to a number of end stations 203, which may include the payer and payee stations discussed above.

For example, the end stations 203 may include a customer end station 203.1, a merchant end station 203.2, a financial institution station 203.3, a second customer end station 203.4, a payer end station 203.5, a payee end station 203.6, which may also be in the form of mobile devices including smart phones and tablet computers, a mobile customer end station 203.7 and a point of sale end station 203.8, and further examples including operation of such end stations 203 will be described in due course.

In use, the base station 201 includes one or more processing systems 210 that can be used in generating transaction codes, storing relevant information associated with transaction codes for subsequent retrieval, and causing funds to be transferred from the payer to the payee. Additionally and/or alternatively, the end stations 203 can be used, for example, by a payee for generating a payment request, or by a payer for obtaining a transaction code and providing authorisation for a payment. The end stations 203 communicate with the base station 201 as required to transfer any other information required to perform the payment.

Suitable portable end stations 203 can be utilised to facilitate the entry of new data for storage by the base station 201, for example the payer may enter payment information to be included in a payment request, and to subsequently be associated with a generated transaction code and stored by the base station 201.

Thus, in one example, the process is implemented at least in part using suitable applications software, which can be loaded on each end station 203 and/or hosted by the processing system 210. The base station 201 is also typically used to store any data required to carry out the actual fund transfer, such as payer or payee account details, payment amounts, or the like. Each end station 203 is typically adapted to communicate with the processing systems 210, allowing transaction codes and associated payment information to be transferred as necessary, and/or to allow authorisations, notifications and the like to be sent as the method progresses. However, this is not essential and any suitable arrangement may be used.

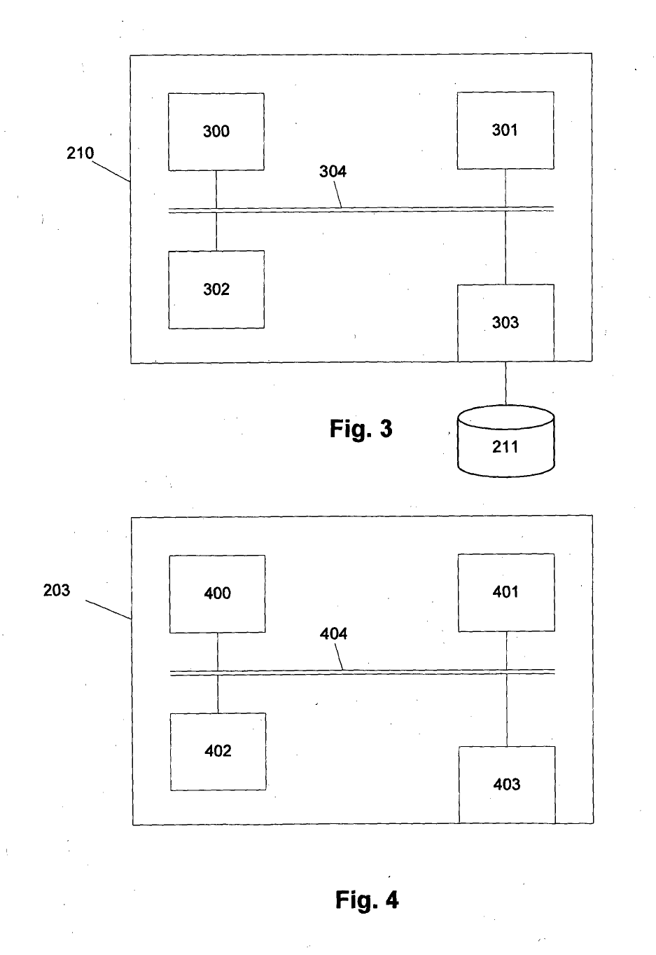

An example of a suitable processing system 210 is shown in FIG. 3. In this example, the processing system 210 includes at least one processor 300, a memory 301, an input/output device 302, such as a keyboard and/or display, and an external interface 303, interconnected via a bus 304 as shown. In this example the external interface 303 can be utilised for connecting the processing system 210 to peripheral devices, such as the communications networks 202, 204, databases 211, other storage devices, or the like. Although a single external interface 303 is shown, this is for the purpose of example only, and in practice, multiple interfaces using various methods (e.g. Ethernet, serial, USB, wireless or the like) may be provided.

In use, the processor 300 executes instructions in the form of applications software stored in the memory 301 to allow the process to be performed, or to provide access to any data required by the end stations 203. Accordingly, it will be appreciated that the processing system 300 may be formed from any suitable processing system, such as a suitably programmed computer system, PC, web server, network server, or the like.

As shown in FIG. 4, in one example, the end station 203 includes at least one processor 400, a memory 401, an input/output device 402, such as a keyboard and/or display, and an external interface 403, interconnected via a bus 404 as shown. In this example the external interface 403 can be utilised for connecting the end station 203 to peripheral devices, such as the communications networks 202, 204, databases 211, other storage devices, or the like. Although a single external interface 403 is shown, this is for the purpose of example only, and in practice multiple interfaces using various methods (e.g. Ethernet, serial, USB, wireless or the like) may be provided.

In use, the processor 400 executes instructions in the form of applications software stored in the memory 401 to allow communication with the base station 201, to perform aspects of the payment method, to allow a user to interact with applications software hosted by the base station 201 and/or to view or modify data, as will be described in more detail below. Accordingly, it will be appreciated that the end stations 203 may be formed from any suitable processing system, such as a suitably programmed PC, Internet terminal, lap-top, hand-held PC, mobile phone, or other communications device, which is typically operating applications software.

It will be appreciated that one example of a particularly well suited processing system configuration will involve the use of hand-held mobile devices as end stations 203 in wireless communication with a base station 201. This configuration allows users (payers or payees) to conveniently access payment method functionalities remotely at the end stations 203 whilst performing their duties, but with storage and heavy processing tasks such as database queries being performed centrally at the base station 201.

In one example, the base station 201 is a server including the processing system 210 and database 211, and end stations 203 are hand-held wireless devices that can display information to, and receive input from, a user via a touch screen GUI, such as smart phones or tablet computers. In particular, the end stations 203 execute local application software to perform user interface functionalities such as presenting options to a user for selection by the user, receiving data input by the user and providing indications to the user. Furthermore, the end stations 203 communicate wirelessly with the base station 201 to provide or receive instructions, requests, or data to the base station 201.

In one example, end stations 203 may be provided as computer terminals to allow the use of other user interfaces, such as a keyboard and mouse, and the display of increased volumes of information to the user on a screen having a larger size than the hand-held devices, via a web interface, or the like. In one example, such a computer terminal allows direct queries of the database 211 by the user. A combination of hand-held devices and computer terminals may be used to allow the respective benefits for each type of end station 203 to be realised.

It will be appreciated that any appropriately configured end stations 203 may be used to deliver similar functionality, and these may be provided as off-the-shelf devices such as mobile phones, PDAs, laptops, tablet computers or the like, or as custom-designed devices.

It will also be appreciated that the partitioning of functionality between the end stations 203 and base station 201 may vary, depending on the particular implementation. In this regard, the end stations 203 may be simplified to provide a user interface only, and in this case the base station 201 may handle the majority of processing tasks. On the other hand, the end stations 203 may be equipped with substantial processing power, such that the base station 201 merely acts as a database server for providing required information to the end stations 203 for remote processing.

In any event, the general process described above is not particularly limited by the hardware implementation, and the skilled person will understand that variations in the processing system architecture will be possible.

In the following specific example methods, it will be assumed that the methods are performed using an end station 203 in the forms of a computer terminal or a mobile computing device, and particular requirements for one or the other type of end station 203 will be identified as appropriate to the particular example. In any case, the end station 203 is assumed to have the capability to communicate with a base station 201 as required, but the end station 203 will be able to perform at least some of the functionalities in the absence of communications with the base station 201, unless otherwise specified.

However, it will be appreciated that the above described configuration assumed for the purpose of the following examples is not essential, and numerous other configurations may be used.

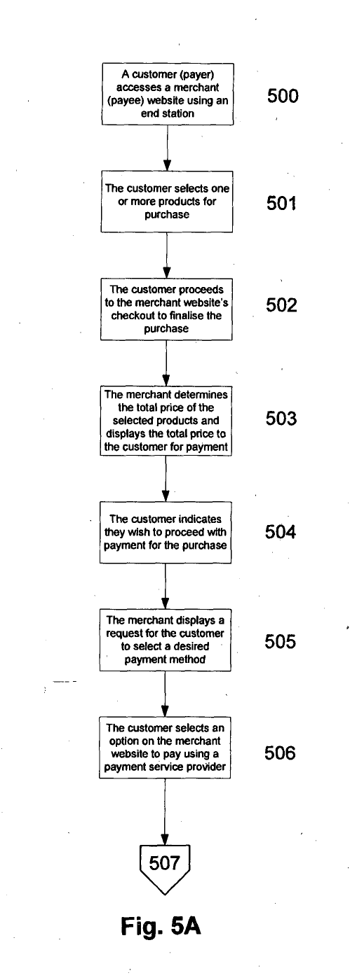

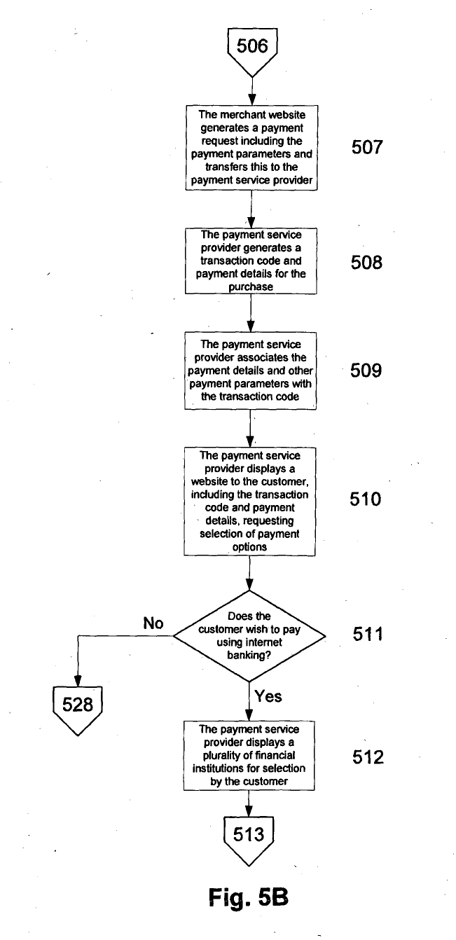

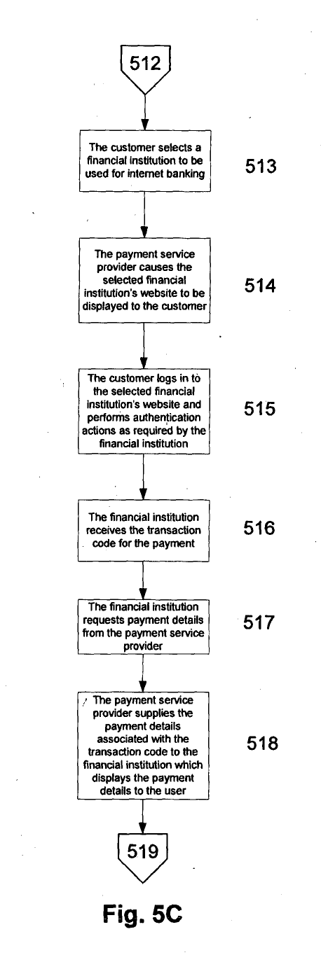

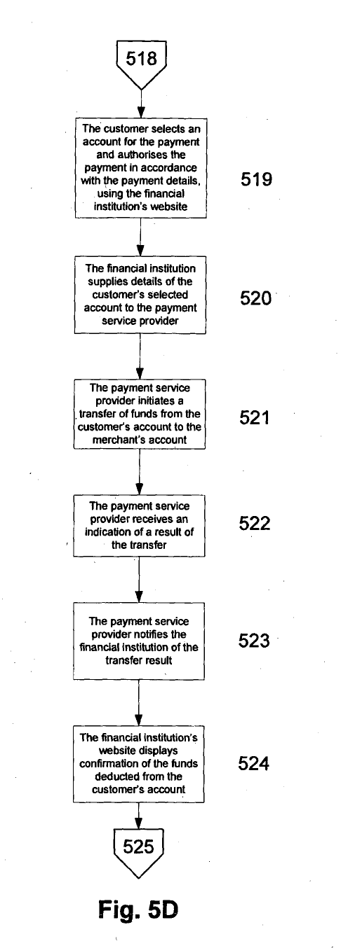

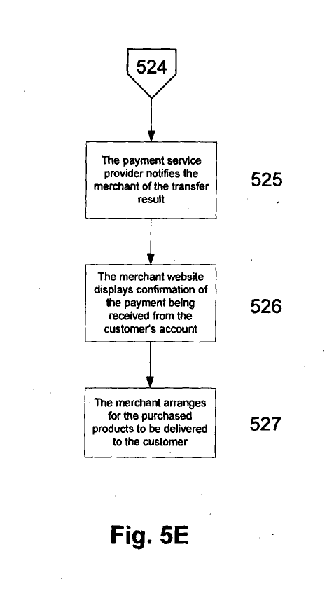

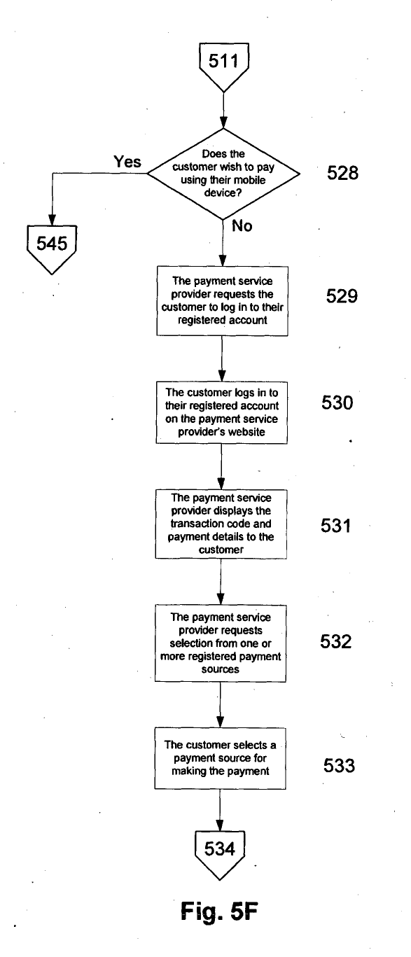

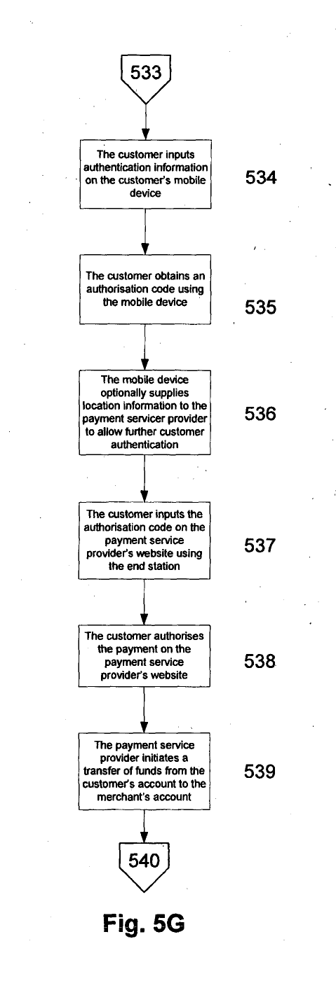

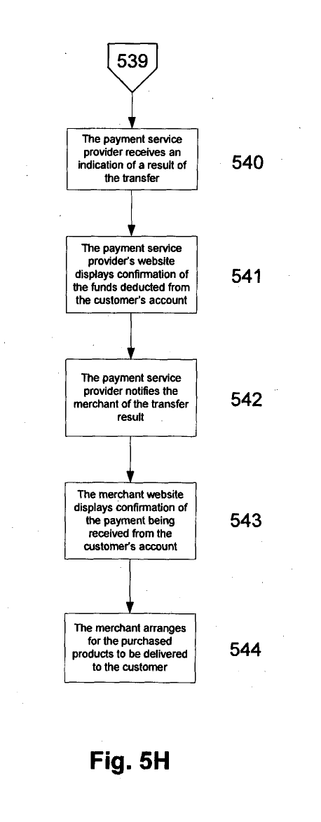

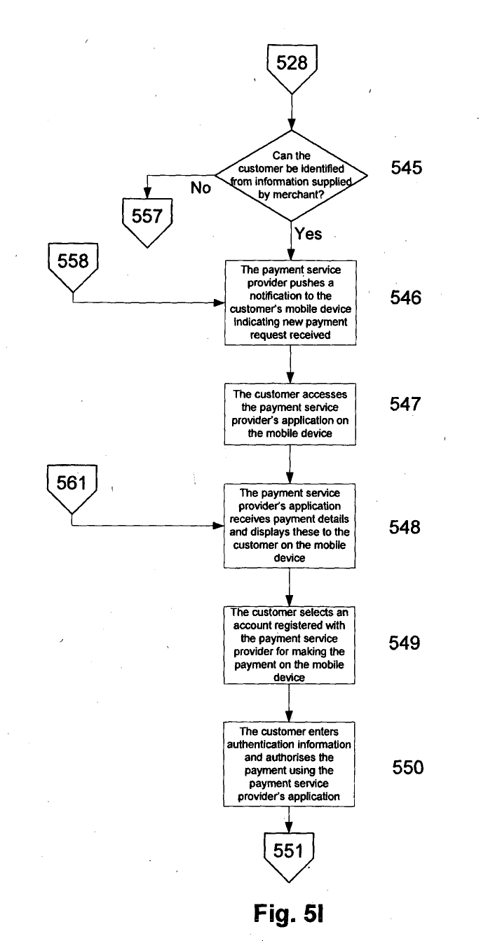

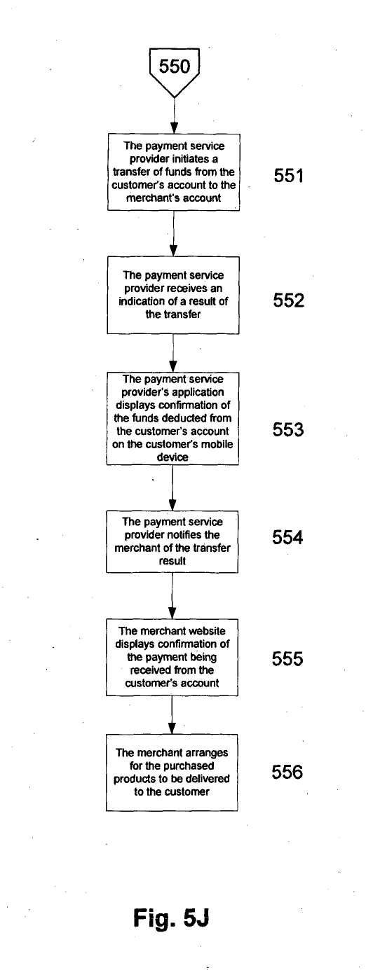

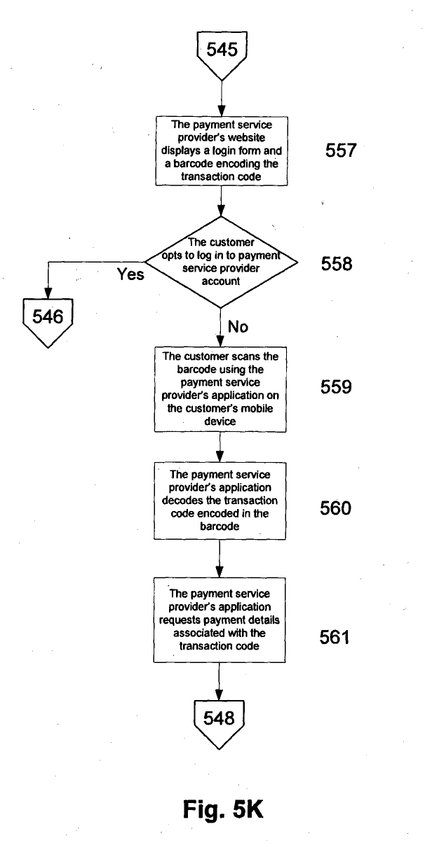

In order to illustrate further preferred features of the payment method and system, a further detailed example method for performing a payment will now be described with reference to FIGS. 5A to 5K.

This example method generally relates to performing a payment for an online purchase. Accordingly, in this example the payee will be a merchant having a merchant website which allows online purchases to be made, with the payment method being used to facilitate the payment. The merchant website is typically hosted by an end station 203 in the form of a web server which may serve the role of the payee station as discussed above. The payer will be a customer accessing the merchant website using another end station 203. The customer's end station 203 may be any computing device capable of allowing the customer to interact with the merchant website, and for allowing other communications as required throughout the method, and maybe referred to as the payer station.

The method begins at step 500, where the customer uses their end station 203 to access the merchant website. As per typical online purchasing procedures, the customer interacts with the merchant website to select one or more products for purchase at step 501. When the customer's selection is complete, the customer proceeds, at step 502, to the merchant website's “checkout” page (or equivalent) to finalise the purchase. At the checkout page, the merchant will typically determine the total price for the selected products and display this total price to the customer for payment, as shown at step 503. Assuming the customer is satisfied with their selection and the displayed total price, the customer then indicates that they wish to proceed with payment for the purchase, at step 504.

This method assumes the customer already has an active registration with the merchant website, and thus the merchant website already has access to customer information such as a delivery address, to allow the products to be delivered once the payment has been confirmed. However, if this is not the case the customer may be required to enter such information at this stage.

It will be appreciated that the payment method up to this point follows a conventional online shopping process, and thus this method may encompass other typical steps performed by a customer selecting products for purchase online. However, the forthcoming steps for arranging the actual payment of the process may deviate from such conventional online shopping processes.

At step 505, the merchant displays a request to the customer to select a desired payment method. Although the merchant may provide the customer with conventional payment method options, at least option presented to the customer will correspond to performing the payment using a payment service provider operating a payment processing station, in accordance with the present method. Accordingly at step 506 the customer selects the option on the merchant website to pay using a payment service provider.

It is noted that, in a conventional online purchase, the merchant website would often proceed to directly request details from the customer to allow payment to be made. For example, the merchant website might prompt the customer to (securely) enter credit card details and other verification information to allow payment using a credit card transaction. In this method, however, the merchant website does not receive these types of sensitive payment details from the customer. Instead, the payment will be facilitated by the payment service provider.

At step 507, the merchant website generates a payment request and transfers this to the payment service provider. The payment request will generally include details of the payment to be made by the customer, sufficient to allow the payment service provider to facilitate the subsequent payment steps without requiring ongoing communication with the merchant, except to provide notification to the merchant when the payment has been successfully performed.

Accordingly, the payment request may include one or more of a range of payment request parameters, which will generally involve at least some information which will be used to generate the payment details. The amount of funds to be paid will generally be required as part of the payment request parameters and these will in turn form part of the payment details, although in some circumstances this may not be required, such as for donations or for voluntary payment amounts.

The payment request parameters may also include identification of the merchant's account into which payment is to be made. This may be in the form of a complete account number, or in cases where the merchant has already registered account details with the payment service provider, the account may be identified in a shortened form. As part of the payment request parameters the merchant may further provide a payee reference for the payment, to allow the merchant to later reconcile the payment. Details of purchased products associated with the payment can also be included in the payment request parameters.

The payment request parameters may also set out conditions on how the payment can actually be made. For instance, the condition parameters may include whether the payment can be made in parts, whether the payment can be overpaid, whether payment must be made within a limited duration of time, and whether the payment is a recurring payment. Conditions of these types will be explored further in due course.

In this example, the merchant website transfers the payment request using a secure connection to the payment processing station operated by the payment service provider. For instance, the transfer may be made using a HTTP Secure POST request. However, it will be appreciated that any suitable transfer mechanism may be used and further examples will be identified in due course.

In any event, upon receipt of the payment request, the payment service provider uses the payment request to generate a transaction code and payment details for the purchase at step 508. The transaction code is used throughout the subsequent steps of the payment method as a reference for the payment and may also be used to provide a receipt number once the payment has been made successfully. The payment details may include, for example, particular portions of the information supplied in the payment request parameters, or other details of the payment which may be derived from the payment request parameters or from the identity of the merchant.

In general, the transaction code will include a string of alphanumeric characters, which will typically be constructed such that predetermined character positions within the transaction code can be used to encode at least some information regarding at least one of the payee and the payment. For instance, the transaction code may include character positions reserved for use in identifying the country in which the payee resides, an identifier associated with the payee, characters to allow identification of a target account for the payment, an identifier unique to the transaction requested by the payee, checksum characters, and the like.

In one example, the transaction code is generated using a base 36 numeral system, which allows improved information density for a given number of characters, whilst allowing the use of typical Arabic numerals 0-9 and case-insensitive Latin alphabet letters a-z. The number of characters in the transaction code string will depend on the information to be encoded and the particular scheme for encoding that information, and thus may vary based on the particular implementation of the method. The transaction code may also allow for the use of a padding character, such as a “dash” character, which may be beneficial depending on the encoding/decoding strategy used.

Having generated the transaction code and payment details, the payment service provider associates the payment details, and optionally, other payment request parameters with the transaction code at step 509. This may be performed by using the transaction code as a key in a relational database of the payment processing station, or the like. This allows information regarding the payment to be retrieved from the payment service provider as required at later stages throughout the method, using the transaction code as a sole reference for the payment.

The payment service provider then displays a new web page to the customer requesting further selection of payment options from the customer, at step 510. At this time the payment service provider will typically also display the transaction code and payment details to the customer, and may also optionally display other information regarding the payment request parameters, for the customer's benefit. The web page may be presented in a new window or tab in a web browser of the end station 203 being operated by the customer, or may be presented by a redirection from the merchant web page in the same window/tab.

In this example, the payment option selection web page may prompt the customer to indicate whether they wish to make the payment using internet banking, as indicated at step 511. In the event the customer responds in the positive, the payment service provider will then proceed to display on the web page a plurality of financial institutions for selection by the customer, at step 512. The alternative scenario in which internet banking is not used will be expanded upon further below from step 528 onwards.

At step 513, the customer selects a financial institution to be used for making the payment via internet banking. The payment service provider then responds to this selection by causing a login page of the selected financial institution's website to be displayed to the customer, at step 514. Again, this may be through opening a new browser window or tab, or by redirection from the payment service provider's web page.

Assuming the customer has selected a financial institution with whom the customer holds an account for which internet banking is enabled, the customer can then log in to the selected financial institution's website and perform any authentication actions as required by the financial institution, at step 515. In this branch of the method then, it will be apparent that the financial institution will be responsible for authenticating the payer's identity, rather than the payment service provider, and thus the authentication methods will depend on those required by the particular selected financial institution.

After the customer has successfully logged in to the financial institution, step 516 then involves the financial institution receiving the transaction code for the payment. This can occur in a number of ways depending on the financial institution's preferences and whether the payment service provider has a pre-existing relationship with the financial institution, for example.

In the case where the transaction code was displayed to the user at the payment options selection web page, and this web page is still active, the customer may simply copy and paste the transaction code from the payment options selection web page into a field on the financial institution web page. For convenience, the financial institution may present such a field immediately after the customer logs in. In one example, the transaction code may be automatically copied into a “clipboard” memory or the like of the customer end station to allow this to be easily pasted into the financial institution web page field without requiring the customer to remember to copy the transaction code.

In another example however, the transaction code may be supplied to the financial institution, by the payment service provider, as a background process. Accordingly, the financial institution may already have the transaction code in its possession when the customer logs in to the financial institution website. In this case, it may be convenient to have the financial institution website highlight the received transaction code to the customer immediately after login, such that the customer is led directly to the next steps for completing payment, rather than having to manually navigate to the appropriate part of the financial institution website.

In any event, after the financial institution has received the transaction code, the financial institutions will then typically request other payment details from the payment service provider as shown in step 517, using the transaction code as a reference. This may involve the financial institution issuing a query to the payment service provider for the provision of particular, payment details associated with the transaction code. Other payment request parameters may also be optionally requested, depending on the financial institution's preferences.

The payment service provider then responds at step 518 by supplying, to the financial institution, the requested payment details associated with the transaction code. The financial institution can then display at least some of the payment details to the customer via the financial institution's website, along with a prompt for confirmation of the payment based on the payment information.

Accordingly, at step 519, the customer selects an account for the payment and authorises the payment in accordance with the payment details, using the financial institution's website. The account selection may be performed using any convenient web-based interface, such as by using a drop-down list, selection checkboxes, or the like. Once confirmation has been received, the financial institution supplies details of the customer's selected account to the payment service provider at step 520.

The supply of account details will effectively provide the payment service provider with confirmation to proceed with the transaction, and thus at step 521, the payment service provider will initiate a transfer of funds from the customer's account to the merchant's account. As discussed above, this transfer may be suitably performed by providing account details and payment details to an electronic funds transfer switch, which, for example, may be separate to, or integrated with the payment processing station.

Next, at step 522, the payment service provider will receive an indication of a result of the transfer. This will usually be an indication of a successful or unsuccessful transfer. In either case the result will be propagated to the customer and merchant, but the following steps will assume a successful result.

At step 523, the payment service provider notifies the financial institution of the transfer result, after which (assuming a successful result) the financial institution's website will display confirmation of the funds deducted from the customer's account at step 524. Alternatively, in the case of an unsuccessful result, the financial institution would inform the customer of the failed transaction and provide prompts to make another attempt, with options to change the selected account, for instance.

The payment service provider will also notify the merchant of the transfer result at step 525. Assuming success once again, at step 526 the merchant website will display confirmation of the payment being received from the customer's account. If the transaction was unsuccessful, the customer would likely have already been informed of this by the financial institution and may be given the opportunity for another attempt, so the merchant would not necessarily also inform the customer of transaction failure.

Given that this example method relates to an online purchase of products, the successful payment will then typically be followed by the merchant arranging for the purchased products to be delivered to the customer, at step 527.

Although this represents an endpoint for the branch of the method in which the customer opted to pay using internet banking at step 511, there are other method branches in which the customer responded that they did not wish to use internet banking, and these will be described from step 528 onwards, starting on FIG. 5F.

Accordingly, in the event the customer does not use internet banking at step 511, it is generally assumed that the customer wishes to instead make the payment by interacting directly with the payment service provider. This interaction can be either continued via websites on a first end station 203 upon which the customer selected and confirmed the products for purchase, or via a second end station 203 in the form of a mobile device of the customer. The customer will typically be prompted to choose whether to pay using their mobile device, as shown at step 528.

If the customer chooses not to pay using their mobile device at step 528, the method will then proceed to step 529, in which the payment service provider requests the customer to log in to a registered account with the payment service provider. This method assumes the customer already has such an account, but if this is not the case the customer may be given the opportunity to establish a new account.

In any case, at step 530, the customer logs in to their registered account using the payment service provider's website. As will be appreciated, the following steps are similar to those discussed above when payment was made using internet banking, but in this case the customer deals only with the payment service provider and not via a separate financial institution's website. This means that the responsibility for authentication of the customer's identity now falls on the payment service provider.

At step 531, the payment service provider displays the transaction code and payment details to the customer, and at step 532, the payment service provider requests selection from one or more registered payment sources. By having pre-registered payment sources, the customer can rapidly progress the payment, but there may nevertheless be an option to register a new payment source at this stage. At step 533, the customer selects a payment source for making the payment.

As mentioned above, the payment service provider is responsible for authenticating the customer's identity. This will be understood to have a substantial impact on the overall security of the payment method, as a strong authentication of the customer's identity will help to remove the risk of performing transactions unauthorised by the customer. The authentication can be conducted in any manner presently used in the art by financial institutions and the like. However in this example the authentication will involve the use of a mobile device of known identity, which is associated with the customer's account.

The customer accesses the mobile device at step 534, and inputs authentication information, such as a personal identification number (PIN) or the like, into the mobile device using application software, such as a smartphone application, provided by the payment service provider.

Having authenticated their identity on the mobile device, the customer then obtains an authorisation code using the mobile device, at step 535. This authorisation code will ultimately be used to confirm that the customer is in possession of the mobile device when providing authorisation for the payment, as an additional layer of security.

The payment service provider may send the authorisation code to the customer's registered mobile device, in which case the payment service provider will have knowledge of the authorisation code that was sent, for later confirmation. Alternatively, the authorisation code may be in the form of a One Time Password (OTP), which may be generated locally on the customer's mobile device. In this case, although the OTP will not have been provided by the payment service provider, the payment service provider may nevertheless be able to confirm the source of authorisation for the payment using the OTP given knowledge of the generation algorithm used by the mobile device. For instance, the OTP generation may use an RSA algorithm in which a decryption key for OTP codes generated by that particular mobile device is known by the payment service provider.

At step 536, the mobile device may also optionally supply location information to the payment service provider to allow further verification of the customer. For instance, the location of the mobile device may be checked against a location of the first end station 203 by which the customer initiated the purchase, using an IP address or other location data. Optionally, other means of authentication, such as biometric authentication or the like, may also be used.

In any event, after successful authentication the customer will have knowledge of the authorisation code. At step 537, the authorisation code will be input, by the customer, into the payment service provider's website using the first end station 203. This input effectively confirms that the customer also has the registered mobile device in their possession.

At step 538 the customer can finally authorise the payment on the payment service provider's website, and this will be followed by the payment service provider initiating a transfer of funds from the customer's account to the merchant's account.

The subsequent transaction processing steps will be similar to those already discussed above for the payment by internet banking, but with different notifications of success to the customer, as this will now no longer involve the financial institution. Substantially similar steps will be discussed only briefly.

At step 540, the payment service provider receives an indication of the result of the transfer. In this branch of the method, the payment service provider's website displays confirmation of the funds deducted from the customer's account at step 541 (rather than this being provided via the financial institution's website).

Otherwise the merchant-end steps are similar to those discussed above for the internet banking option. At step 542 the payment service provider notifies the merchant of the transfer result, after which, at step 543, the merchant website displays confirmation of the payment being received, and the merchant will then typically arrange delivery of the purchased products at step 544.

The other option at previously discussed step 528 was for the customer to actually complete, the payment steps using their mobile device. If the customer responds in the affirmative at step 528, the method proceeds to step 545 shown of FIG. 51.

At step 545, the payment service provider will first determine whether the Customer can be identified from information supplied by the merchant. In other words, there is a check on whether sufficient identification information is available to allow the customer's registration with the payment service provider to be reliably identified, so that payment using the customer's registered mobile device can be begin without requiring further identification data from the customer.

In general, if the customer has entered billing or shipping address information on the merchant website, and this information is passed on to the payment service provider, then this may be sufficient to allow the payment to proceed using the mobile device. However, this may not always be the case, and the possibility of insufficient customer identification will be explored in greater detail in due course.

However, in the event there is sufficient identifying information at step 545, the payment service provider will be able to then push notification to the customer's registered mobile device, indicating a new payment request has been received, at step 546. This notification may be through any suitable means. For instance, a text message may be sent to the mobile device. Otherwise a pop-up box or other form of notification dialogue may be triggered on the mobile device. These options may utilise application software running on the mobile device.

In any event, the notification will usually prompt the customer to access the payment service provider's application software on the mobile device, which is assumed to occur at step 547. The application may be already running or may be automatically executed after the customer responds to the notification, or the customer may need to execute the application manually.

In any case, once the customer accesses the payment service provider's application, the application will receive payment details and display these to the customer on the mobile device, at step 548. This may be done by querying the payment processing station for the payment details, based on the transaction code which may have been pushed to the mobile device along with the notification.

At step 549, the customer selects an account registered with the payment service provider for making the payment on the mobile device. The customer then enters authentication information, such as a PIN number, biometric data, or the like, and confirms the payment using the payment service provider's application, at step 550. Accordingly, in this branch of the method, the customer completes the authentication and payment authorisation steps using the mobile device only, and no other entry of information into the payment service provider's website using the first end station 203 is required. This is in contrast with the above optional steps where the mobile device was only used to provide an authorisation code to the customer, for entry into the payment service provider's website as part of the payment authorisation.

Since mobile devices typically have relatively strong hardware-based security mechanisms, authorisation for proceeding with the payment using a mobile device can be further verified by using those security mechanisms. For instance, the registration of a customer's mobile device may include details of hardware identification numbers which are practically very difficult to defraud. Again, location based verification may also be used for comparison against the originating IP address of the first end station 203 upon which the purchase was initiated.

At step 551, the payment service provider will then proceed to initiate the transfer of funds from the customer's account to the merchant's account, which will be followed by receipt of an indication of the result of the transfer at step 552.

The payment service provider's application displays confirmation of the funds deducted from the customer's account on the customer's mobile device at step 553. This is different to the online banking and mobile device authorisation code branches of the method, in which the confirmations of the transaction result were delivered via websites on the end station 203 by which the purchase was initiated.

Otherwise the merchant-end steps are also similar to those discussed above. At step 554 the payment service provider notifies the merchant of the transfer result, after which, at step 555, the merchant website displays confirmation of the payment being received, and the merchant will then typically arrange delivery of the purchased products at step 556.

As discussed above at step 545, there may be occasions where insufficient information for identifying the customer and thus their registered mobile device details are available from the information supplied by the merchant. In those occasions, the method may proceed to step 557 where the payment service provider's website displays a login form and a barcode encoding the transaction code.

The customer may simply opt to log in to their payment service provider account via the website at step 558, after which the payment service provider will now be able to definitively identify the customer, such that the payment using the mobile device can then proceed as already described, from step 546 onwards.

However, the customer may choose to avoid the additional steps of entering log in information using the end station 203 from which the customer accessed the merchant website. Instead, the customer may scan the barcode using the payment service provider's application on the mobile device, at step 559. Since the barcode encodes the transaction code, the payment service provider's application can decode the transaction code from the barcode at step 560, to thereby obtain the transaction code directly. Thus, in this case the payment service provider does not need to definitively identify the customer to allow communication with their registered mobile device. Instead, the link to the customer's identity is established via the mobile device, and the application can then initiate communications with the payment processing station.

At step 561, the payment service provider's application will then request payment details associated with the transaction code. This leads the method back to the previously discussed step 548, where the payment service provider's application receives payment details and displays these to the customer on the mobile device for subsequent account selection, authentication and authorisation of the payment as per the steps following step 548.

A further illustrative example of a payment method will now be described to highlight how the payment method can also be used in making payments that are not necessarily associated with an online purchase. This method makes use of the barcode scanning functionality discussed above to allow a payer, such as a customer, to receive details of a payment by simply obtaining and scanning a barcode.

This example method begins at step 600, where a payee desires a payment from a payer. This payment need not be for purchased goods. Indeed, the payment can simply be the transfer of funds between individuals, for whatever reason. The payment may be a donation to charity, a gift, a settling of debts accrued, or the like. The payment may also be for services, such as financial or insurance services, which may be paid in response to monthly, quarterly, or annual invoices, for example.

In any case, it will be appreciated that, in accordance with the above described general form of the payment method, the payee will initiate the payment method by generating a payment request, including payment request parameters, at step 601. The payee then supplies the payment request to the payment service provider at step 602. This can be done in a similar manner as per similar steps described in the above example. However, since this method is not necessarily associated with an online purchase, the payment request may be supplied in methods other than electronic communication (i.e. web-based communications for example). Nevertheless, it will generally be convenient to use electronic communications methods to supply the request.

In the event that the payment is in relation to billings by a service provider or the like, it may be the case that the service provider has a number of different bills requiring different payments from different individuals. There is thus the option for the payee to issue a plurality of payment requests in a batch of payment requests sent to the payment service provider.

In the event the payee is an individual desiring a payment from another individual, each individual may use a respective mobile device to either request or confirm the payment, depending on the individual's role in the payment method. Accordingly, in such a case, the payee may generate the payment request using the payment service provider's application software on their mobile device and the supply of the payment request would then be via mobile communications from the mobile device to the payment service provider's payment processing station.

In any case, the payment service provider will respond to the payment request at step 603 by generating a transaction code and payment details using the payment request, in a similar fashion to previously described forms of the method. The subsequent step 604 of the payment service provider associating the payment details and other payment parameters with the transaction code will also be similar to earlier described methods.

Having generated the transaction code, the payment service provider then supplies the transaction code to the payee at step 605. It will be appreciated that this differs from previously described methods, since it was not always necessary for the transaction code to be supplied to the payee for the payment to be progressed. However, in this case, the payee requires the transaction code, to generate a barcode encoding the transaction code at step 606. The barcode may be generated using any known barcode encoding techniques. In one example, the payment service provider's application software may be used by the payee to generate the barcode. This can help to ensure that barcodes are encoded in a consistent manner to simplify later decoding.

The payee then presents the barcode to the payer at step 607. The manner of presenting the barcode will depend on the payee's requirements. In one example, the barcode may be printed onto a payment invoice or the like, to allow payment corresponding to the invoice. In one example, the payee may allow a payment period within which the payment can subsequently be made, with penalty fees payable if the payment is not made within the payment period.

The barcode may alternatively be printed onto any other object to allow scanning. For example, the barcode may be printed onto advertising materials, onto shelf labelling, directly onto a product or onto a label to be attached to the product, or provided in any other printed form. It will be appreciated that there are a multitude of options for use of the barcode in this way, which can allow a variety of payments to be made.

As described above in the online purchase method, the barcode may alternatively be presented on a website being accessed by the payer.

In the case of an individual to individual payment where the payee and payer use respective mobile devices, the payee may generate the barcode on their mobile device using the payment service provider's application software, and then present the barcode to the payer by displaying the barcode on a display of their mobile device to allow scanning by the payer's mobile device.

In any case, at step 608, the payer scans the barcode using the payment service provider's application software on the payer's mobile device. In the individual to individual payment case, this will require the payee and the payer to be in one another's immediate vicinity at the time of scanning the barcode. Other cases, however, can allow the payee and the payer to be located remotely from one another when scanning occurs, such as when the barcode is printed on an invoice. The payment service provider's application decodes the transaction code encoded in the barcode at step 609.

The following steps will be similar to those described above with respect to payment using a mobile device. At step 610, the payment service provider's application on the payer's mobile device requests, from the payment service provider, payment details associated with the transaction code. The application then receives payment details and displays these to the payer on the payer's mobile device at step 611.

In a similar manner as discussed above for the mobile device payment example, the payer then enters authentication information and authorises the payment using the payments service provider's application on the mobile device, at step 612.

This authorisation allows the payment service provider to initiate the transfer of funds from the payer's account to the payee's account at step 613. Following this, the payment service provider receives an indication of a result of the transfer. The payment service provider's application will then display confirmation of the funds deducted from the payer's account on the payer's mobile device at step 615.

The payment service provider will also notify the payee of the transfer result at step 616. In general, the notification will be supplied in a manner that reciprocates the payment request method. In the event the payee used their mobile device to request the payment, this notification may be provided via the same mobile device. A batched set of payment requests may trigger the payment service provider to provide notifications in a corresponding batch, but it may be more desirable to provide notifications as and when payments are made, to prevent undue delay in providing notifications for separate payments.

As per previously described forms of the payment method, the payee may respond to notification of a successful transfer by delivering products, or providing services, etc. However these steps are not required where the payment is not in-exchange for products or services. In any case, a receipt may be provided as evidence of the payment being made, and this receipt may be generated based on the transaction code.

Whilst the above example used a barcode to allow the transaction code to be conveniently provided from the payee to the payer, it will be appreciated that the payee may receive the transaction code from the payer in other ways.

For example, the payment method may proceed in a similar fashion to that described above, but instead of having the payee generate a barcode encoding the transaction code at step 606, the payee may provide the transaction code to the payer in some other form. For instance, the payee may simply have the transaction code displayed on a display of the payee's mobile device, and the payer may simply manually enter the transaction code. However, since this may allow the transaction code to be entered incorrectly, it will generally be desirable to transmit the transaction code to the payer electronically.

Accordingly, in one example, after the payee receives the transaction code, the payee may then electronically transmit the transaction code to the payer's mobile device. This electronic transmission may desirably use wireless communication methods. For instance, a short-range communication technology such as Bluetooth, Near Field Communication (NFC), or the like may be used to allow the transaction code to be transmitted between the payee's and payer's respective mobile devices. Alternatively, the transaction code may be transmitted over longer ranges using a mobile phone Short Message Service (SMS) or the like, in which case a received transaction code may be subsequently used by the payment service provider's application software running on the payer's mobile device. Otherwise the transaction code may be directly sent to the payer's mobile device as per the mobile phone payment method explained above in the context of an online purchase.

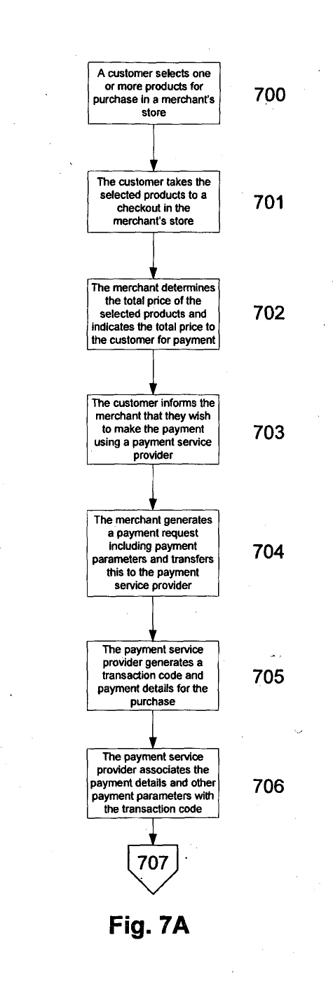

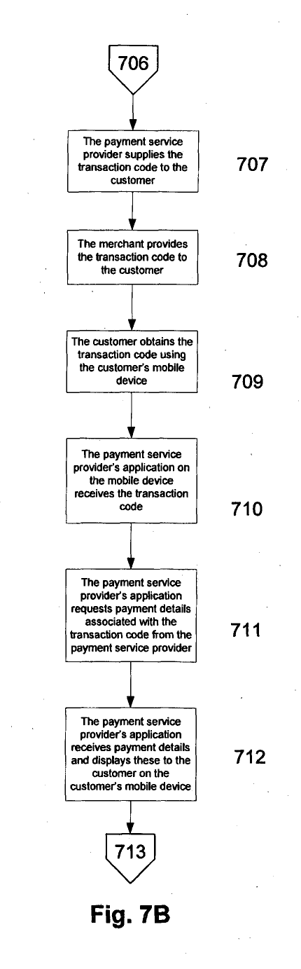

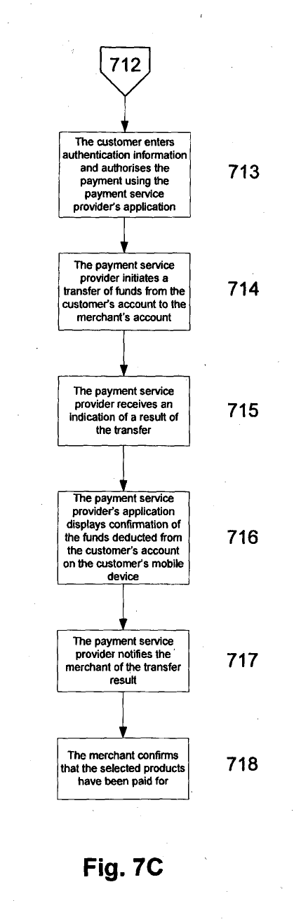

The payment method may also be used to make a payment for a point of sale (POS) transaction, and an illustrative example of such a case will now be described with reference to FIGS. 7A to 7C.

In this example, it will be assumed that the payment will be for an in-store purchase of products from a merchant. Accordingly, the method begins at step 700 where a customer selects one or more products for purchase in the merchant's store. Having selected the desired products, the customer will typically take the products to a checkout in the merchant's store, as shown at step 701.

At step 702, the merchant then determines the total price of the selected products and indicates a total price to the customer for payment. Usually the merchant will ask the customer how they would like to pay for their purchase. In this example, at step 703 the customer informs the merchant that they wish to make the payment using the payment service provider. This method assumes that the merchant has the capability to accept payments made using the payment service provider.

At step 704, the merchant generates a payment request including payment parameters and transfers this to the payment service provider. This request may be suitably generated and transferred using an end station of the merchant at the point of sale. For example, the merchant's end station may be in the form of a computer connected to a cash register at the checkout of the merchant's store, where the computer further has the capability to communicate with the payment service provider.

Upon receiving the payment request, the payment service provider responds by generating a transaction code and payment details for the purchase, as shown at step 705. The payment service provider will also associate the payment details and other payment parameters with the transaction code at step 706.

At step 707, the payment service provider then supplies the transaction code to the customer. Typically the transaction code will be supplied in the same way that the payment request was originally provided to the payment service provider.

The merchant then provides the transaction code to the customer at step 708, and at step 709 the customer obtains the transaction code using the customer's mobile device. The transaction code may be provided by the merchant and obtained by the customer using any suitable technique, including those already described in the above example.

For instance, the transaction code may be made available to the customer by generating barcode encoding the transaction code, and then providing this to the customer by displaying it on a screen of the merchant's end station or printing it on an invoice, such that the customer may scan the barcode to thereby obtain the transaction code, as described above. The transaction code may alternatively be transmitted from the merchant's end station to the customer's mobile, for example by using wireless communications such as Near Field Communication (NFC) techniques or the like.

In any event, the payment service provider's application on the mobile device will ultimately receive the transaction code, as shown at step 710, and the payment method will generally proceed in a similar manner as described in previous examples.

At step 711, the payment service provider's application requests payment details associated with the transaction code from the payment service provider. The payment service provider's application then receives payment details and displays these to the customer on the customer's mobile device at step 712.

The customer then enters authentication information and authorises the payment using the payment service provider's application at step 713, and the payment service provider will respond to successful authentication and payment authorisation by initiating a transfer of funds from the customer's account to the merchant's account as shown at step 714.

As per the previous examples, the payment service provider will then receive an indication of a result of the transfer at step 715, and if this is successful, the payment service provider then displays confirmation of the funds deducted from the customer's account on the customer's mobile device at step 716.

At step 717, the payment service provider also notifies the merchant of the transfer result. This notification may include the transaction code along with a merchant reference number if this was provided as part of the payment request, so that the merchant can more conveniently reconcile the payment.

If the payment was indeed successful, then the merchant can confirm that the selected products have been paid for as shown at step 718, after which the customer may be allowed to take possession of the purchased products. At this point the merchant may also issue a separate payment receipt to the customer.

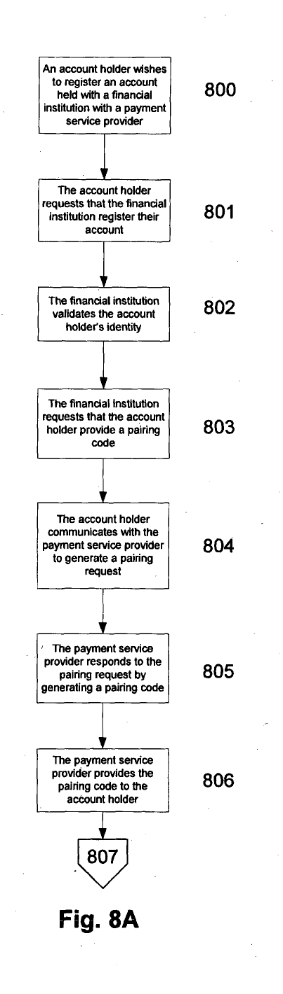

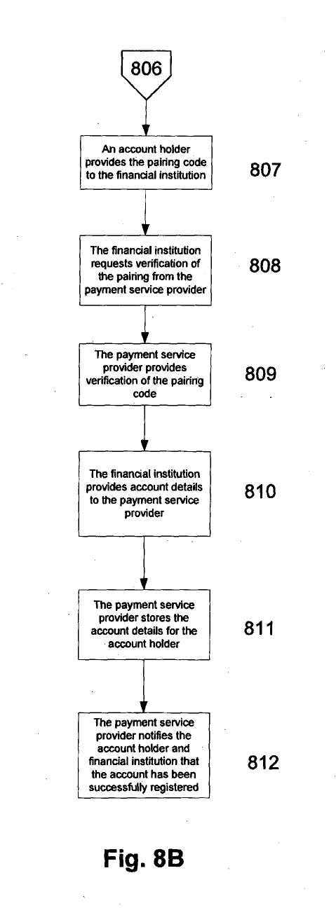

As discussed in the examples above, embodiments of the payment method may involve having a payer or payee register an account with the payment service provider, so that payments can be conveniently made or received using the registered account. Accordingly, an example of a method for registering an account will now be described with reference to FIGS. 8A and 8B.

Preferably, the registration process will be the same irrespective of whether the account holder will be acting as a payer or payee. However, it will be appreciated that in some circumstance the account holder may only wish to make or receive payments, and thus the registration process may be specifically adapted to only register an account holder as a payer or payee.

In any case, the method begins at step 800 when an account holder wishes to register an account held with a financial institution with the payment service provider. The account holder will request that the financial institution register their account, as shown in step 801.

In response to such a request, at step 802 the financial institution will typically validate the account holder's identity, as per the financial institution's usual account security procedures. This validation will generally be the responsibility of the financial institution and the processes used in the validation may be the same as those used to allow changes to be made to the account holder's account. For example, the financial institution may request 100 points of identification before acting on a request to register an account with a payment service provider.

In the case of a joint bank account, the financial institution may require authorisation from each party to the account, depending on the authorisation arrangement for the account. Alternatively, authorisation for an account may be delegated to another party. In any event, this will generally be handled in accordance with the financial institution's existing processes.

Having validated the account holder's identity, the financial institution then requests that the account holder provide a pairing code as shown at step 803, in order to allow the registration to proceed.

At step 804, the account holder communicates with the payment service provider to generate a pairing request for the registration. The account holder may communicate with the payment service provider using any suitable end station. For example, the account holder may log in to the payment service provider's website, or use the payment service provider's application software on a mobile device to generate the pairing request.

In any event, the payment service provider responds to the pairing request by generating a pairing code at step 805, and this pairing code is provided to the account holder at step 806. The pairing code will typically be provided to the account holder in the same manner in which the pairing request was provided to the payment service provider, but this is not essential.

Having received the pairing code, the account holder then provides the pairing code to the financial institution at step 807. It will be appreciated that this can be done in many ways. For example, the pairing code may be displayed on the account holder's mobile device and shown to a representative of the financial institution to allow the financial institution to manually input the pairing code into an end station operated by the financial institution. The pairing code may be encoded into a barcode for scanning by the financial institution. The account holder may manually input the pairing code using a keypad at the financial institution. Alternatively, the account holder may input the pairing code into the financial institution's website, or supply the pairing code remotely in any other manner.

Once the financial institution has obtained the pairing code, the financial institution will typically communicate with the payment service provider to request verification of the pairing, as shown at step 808. At step 809, the payment service provider will provide verification of the pairing. These verification steps provide an additional layer of security to ensure that the financial institution only releases a account holder's account details in response to genuine pairing requests, and to further ensure that the correct account details are about to be released.

Assuming the verification is successful, the financial institution then proceeds to provide the account details to the payment service provider at step 810. It is noted that the account details can be for any number of accounts, depending on the nature of the account holder's request for registration. In any case, the account details provided to the payment service provider will typically be those that the electronic funds transfer switch will understand to credit/debit funds in the account.

The payment service provider subsequently stores the account details for the account holder at step 811. In general these account details will be securely stored and only provided to an electronic funds transfer switch when causing payments to/from the account holder's registered account.

At step 812, the payment service provider notifies the account holder and the financial institution that the account has been successfully registered. The account holder is now able to make or receive payments from the registered account, using the payment service provider.

In one example, a payment may be made in parts, such as by multiple installments made by the same payer, or by a plurality of sub-payments made by different payers (i.e. “bill splitting”). These circumstances may occur in the context of the above example, where each payer uses their respective mobile devices to make a portion of a payment having a transaction code.

In the case of bill splitting, the payee will still generate a payment request, be issued with a transaction code, and generate a barcode encoding the transaction code, as described above. However, the payee may additionally specify in the payment request parameters included in the payment request that the payment can be made in parts, or split between multiple payers.

Accordingly, each payer contributing funds towards the payment can scan the barcode and select a specific amount to be paid. In some circumstances, payers may opt to split the bill equally, and the required amounts may be determined by the payment service provider's application software running in separate instances on each of the payer's mobile devices. Otherwise, each payer may manually enter an amount to be paid. In any case, payment for the nominated amount will proceed in the same manner as discussed above, requiring authentication and authorisation from the user for each sub-payment.

Upon making a sub-payment, each payer will be issued with a receipt number based on the transaction code. The receipt number may be generated by appending an expandable portion of characters to the transaction code's character string, and this expandable portion may be incremented and expanded as required to accommodate the number of sub-payments made towards the total payment amount.

The payment service provider will typically track the successful transactions of funds towards the payment and, once the amount of the payment requested by the payee has been collectively paid by the plurality of payers, a notification to that effect will be provided to at least the payee. In the event a balance is still outstanding on the payment, this may be communicated to payers whom have scanned the barcode. For example, payers whom have already made a sub-payment may be informed of the outstanding balance of the payment as progressive sub-payments are made by other payers. Also, payers whom have only scanned a barcode but have not yet paid an amount may be informed of the remaining balance of the payment to allow an informed selection of the amount to be paid towards the total payment amount.

In some cases, however, a payer may wish to have the total payment made by a single payer, or legislation may otherwise not allow the respective payment to be split, and this may also be specified in the payment request.

In another example, the payer may specify in the payment request parameters that overpayment is allowed. This may be useful in settings where tips are accepted in addition to the basic payment amount, at the discretion of the payer. In such cases, the payer may be prompted to specify an amount for payment that is equal to or greater than the required payment amount, as part of the payment authorisation steps.

In other examples, an open ended payment request might be generated by a payee seeking a donation of an unspecified amount. In these cases, the payment details may be limited to identification of the payee, and the payer will have the freedom to select any payment amount when authorising the payment.

The payment method may further be usefully applied to recurring payments. Although the examples discussed above may all be used for making one-time payments, such as for an online purchase, the method is equally applicable to situations where a payment is repeated at regular intervals. For example, the payment method may be used to allow monthly insurance premiums, subscriptions or the like to be conveniently paid.

In one example, a single transaction code is generated in response to a payment request which specifies a recurring payment is required, but this transaction code can be used in multiple payments. The payer may manually input the transaction code into their mobile device or may scan a barcode at each payment interval. However, it may be more convenient to have the payment service provider push a notification to the payer when each payment interval arises, to thereby allow the payer to simply authorise each recurring payment as they fall due.

In a related example, a transaction code may be generated for payment of funds which relate to a time-limited service, such as on-street parking, and the payment request may specify that the payment can be made multiple times to extend the time duration. For instance, a parking meter may be configured to present the transaction code to a payer wishing to park their car in a respective car park. A payment using that transaction code will correspond to a predetermined parking duration. Once the payer has received the transaction code, additional payments can be made to extend the parking duration. This may be useful, for example, if the payer is delayed and requires additional parking time, as the payer can top-up their parking payment using their mobile device without the need to return to their car.

In another example, the payment method may allow funds in a payer's account to be put on hold in advance of later completion of the transaction. This might be useful, for instance, in opening a bar tab or in making a security deposit. In an illustrative example of a bar tab, a payer may indicate a desired amount for the bar tab to a bartender representing the payee (i.e. the bar owner). The bartender may then generate a payment request specifying that a hold should be placed on that amount in the payer's account until the payment request is finalised. The payer would obtain the corresponding transaction code and authorise this as usual but the payment would not be finalised at this stage. Instead, when the payer closes the bar tab, the bartender can update the transaction account and finalise the payment request, which would cause the final amount of the bar tab to be transferred from the payer's account to the payee. Any remaining funds which were previously on hold would then be released.

As mentioned above, transaction codes may also have an expiry time, which can allow a merchant to manage stock levels and the like in the event a timely payment is not made for products selected by a customer for an online purchase.

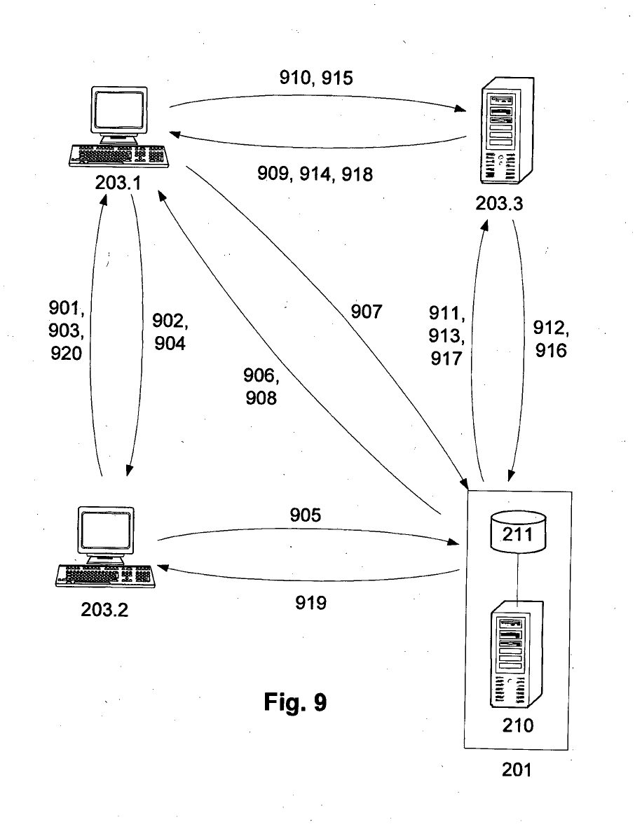

In view of the above example methods, a number of example apparatus configurations for performing the methods will now be outlined, with reference to FIGS. 9 to 13.

The examples of FIGS. 9 to 11 generally correspond to branches of the example method described above with reference to FIGS. 5A to 5K.

FIG. 9 shows an example apparatus configuration for making a payment for an online purchase using internet banking, as described above. In this case, the customer operates a customer end station 203.1, the merchant operates a merchant end station 203.2, each being an instance of a suitable end station 203 as discussed above. The payment service provider operates a payment processing station 201, which is equivalent to the base station 201 as discussed above. Finally, the financial institution operates a financial institution station 203.3, which acts as a further end station 203 in this example.

The merchant end station 203.2 hosts the merchant's website, the payment processing station 201 hosts the payment service provider's website, and the financial institution station 203.3 hosts the financial institution's website.

The particular information transfers between the respective end stations 203.1, 203.2, 203.3 and the base station 201 in performing the internet banking payment will now be described.

At 901 the product details are provided to the customer end station 203.1, via the merchant's website. The customer selects products for purchase and the merchant end station 203.2 receives an indication of the selection at 902. At 903 the merchant end station 203.2 provides a total price to the customer end station 203.1 for payment. At 904 the customer inputs a desire to pay using a payment service provider and this is provided to the merchant end station 203.2.

At 905 the merchant end station provides a payment request to the payment processing station 201. At 906 a transaction code and payment details are then provided to the customer end station 203.1 via the payment service provider's website. The customer indicates that they wish to use internet banking at 907. At 908, the payment service provider then communicates with the customer end station 203.1 to redirect the customer to the financial institution's website at 909.

The customer inputs login information and any other authentication information which is supplied to the financial institution station at 910. In the meantime, the payment processing station 201 transfers the transaction code the financial institution station at 911. The financial institution requests further payment details at 912, and these are provided to the financial institution at 913. The payment details are then transferred on to the customer via the financial institution's website at 914.

The customer provides an account selection and authorisation for the payment to the financial institution at 915. In response, the financial institution forwards account details to the payment service provider at 916.

The payment service provider causes the transfer of funds and after determining the result of the transfer, a notification is sent to the financial institution at 917. The customer subsequently receives a notification from the financial institution at 918. The payment service provider similarly provides notification of the transfer result to the merchant at 919. Finally, at 920 the customer receives confirmation from the merchant that the payment has been received and the products will be shipped to the customer.

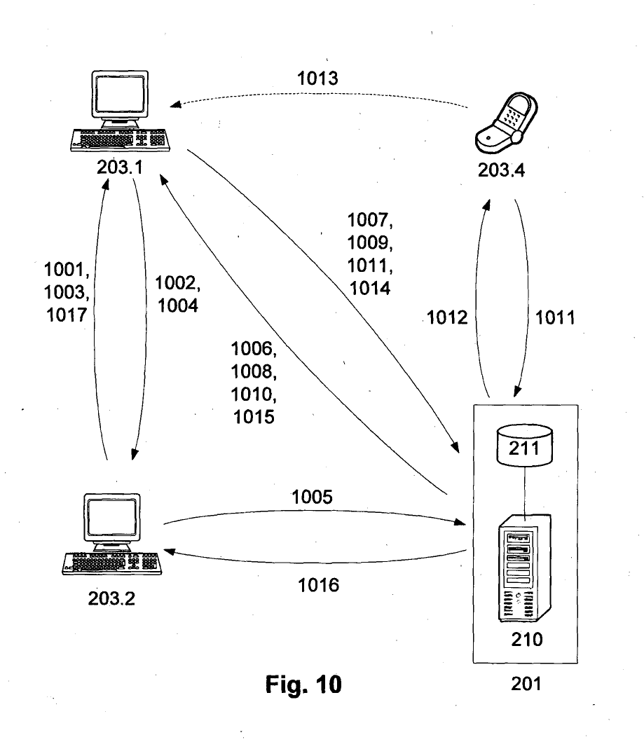

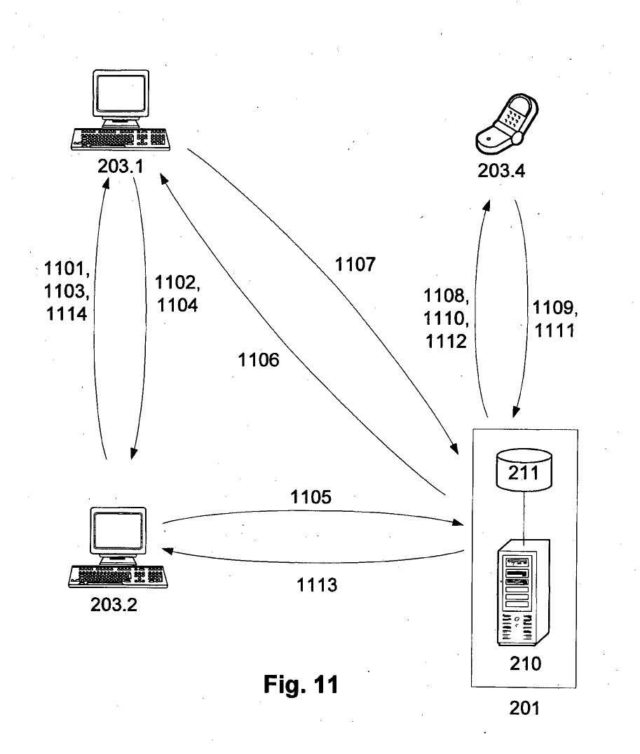

FIG. 10 shows an example apparatus configuration for making a payment for an online purchase using the payment service provider's website with authentication using the customer's mobile device. In this case, the customer operates a first customer end station 203.1 and also operates a second customer end station 203.4, namely the customer's mobile device. As in the previous example, the merchant operates a merchant end station 203.2, and the payment service provider operates a payment processing station 201.

The merchant end station 203.2 hosts the merchant's website, the payment processing station 201 hosts the payment service provider's website. The second customer end station 203.4 runs application software provided by the payment service provider, which allows communications with the payment processing system.

The information transfers between the respective end stations 203.1, 203.2, 203.4 and the base station 201 in performing the payment using the payment service provider's website will now be described.

As per the above example, at 1001 the product details are provided to the customer end station 203.1, via the merchant's website. The customer selects products for purchase and the merchant end station receives an indication of the selection at 1002. At 1003 the merchant end station provides a total price to the customer end station for payment. At 1004 the customer inputs a desire to pay using a payment service provider and this is provided to the merchant end station 203.2.

At 1005 the merchant end station provides a payment request to the payment processing station 201. At 1006 a transaction code and payment details are then provided to the customer end station 203.1 via the payment service provider's web site. The customer indicates that they wish to pay using the payment service provider's website at 1007.

At 1008, the payment service provider then requests login details from the customer. At 1009 the customer supplies the login details. After successful login, the payment service provider's website displays the transaction code and payment details to the first customer end station 203.1 at 1010, for confirmation.

The customer will then access the second customer end station 203.4 (the customer's mobile device) and inputs authentication information which is provided to the payment processing station 201 at 1011. Having authenticated the customer's identity, the payment service provider provides, at 1012 an authorisation code to the second customer end station 203.4.

The customer, having received the authorisation code on the second customer end station 203.4, will then manually input the authorisation code into the first customer end station 203.1 as confirmation that the payment should proceed. This manual transfer of the authorisation code is indicated at 1013. The authorisation code is then transferred to the payment service provider at 1014.

With the transaction now authorised by the customer, the payment service provider then causes the transfer of funds and after determining the result of the transfer, a notification is sent to the customer's first end station 203.1 at 1015. The payment service provider similarly provides notification of the transfer result to the merchant at 1016. Finally, at 1017 the customer receives confirmation from the merchant that the payment has been received and the products will be shipped to the customer.

FIG. 11 shows an example apparatus configuration for making a payment for an online purchase, primarily using the customer's mobile device. As per the previous example, the customer operates the first customer end station 203.1 and the second customer end station 203.4 (the customer's mobile device), the merchant operates a merchant end station 203.2, and the payment service provider operates a payment processing station 201.

The information transfers between the respective end stations 203.1, 203.2, 203.4 and the base station 201 in performing the payment using the customer's mobile device will now be described.

As per the above example, at 1101 the product details are provided to the customer end station 203.1, via the merchant's website. The customer selects products for purchase and the merchant end station receives an indication of the selection at 1102. At 1103 the merchant end station provides a total price to the customer end station for payment. At 1104 the customer inputs a desire to pay using a payment service provider and this is provided to the merchant end station 203.2.

At 1105 the merchant end station provides a payment request to the payment processing station 201. At 1106 a transaction code and payment details are then provided to the first customer end station 203.1 via the payment service provider's website. The customer indicates that they wish to pay using the customer's mobile device at 1107.

Assuming the payment service provider has received sufficient information from the merchant to identify the customer, at 1108 the payment processing station 201 will transfer the transaction code to the customer's registered mobile device, namely the second customer end station 203.4, and notify the customer of the new payment.

The customer accesses the second customer end station 203.4 and this triggers a request to the service processing station for payment details at 1109. Payment details are subsequently provided to the second customer end station 203.4 at 1110.

The customer uses the second customer end station 203.4 to select an account for the payment, enter authentication information, and authorise the payment, and the relevant information is provided to the payment processing station 201 at 1111, to allow the payment to proceed.

With the transaction now authorised by the customer, the payment service provider then causes the transfer of funds. After determining the result of the transfer, a notification is sent to the customer's second end station 203.4 at 1112. The payment service provider also provides notification of the transfer result to the merchant at 1113. Finally, at 1114 the customer receives confirmation from the merchant that the payment has been received and the products will be shipped to the customer.

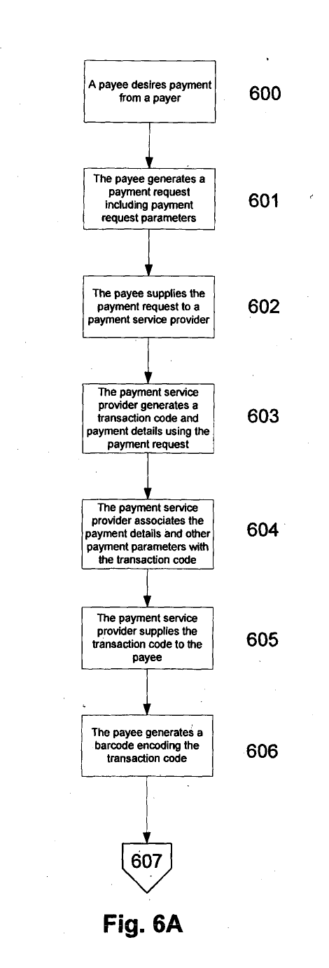

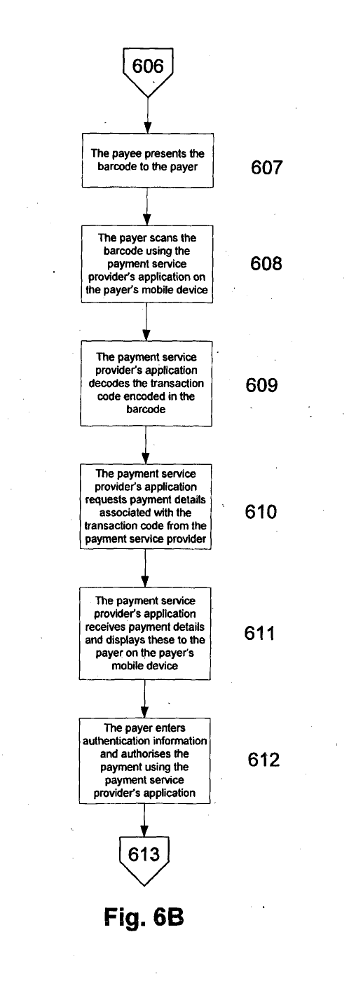

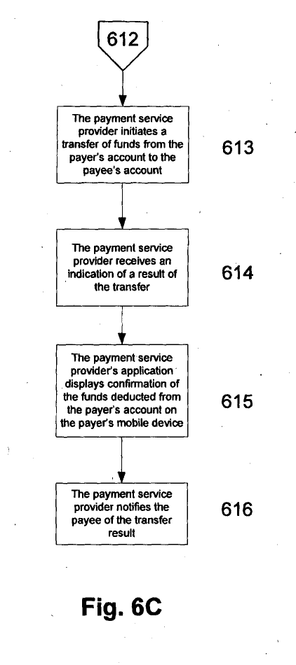

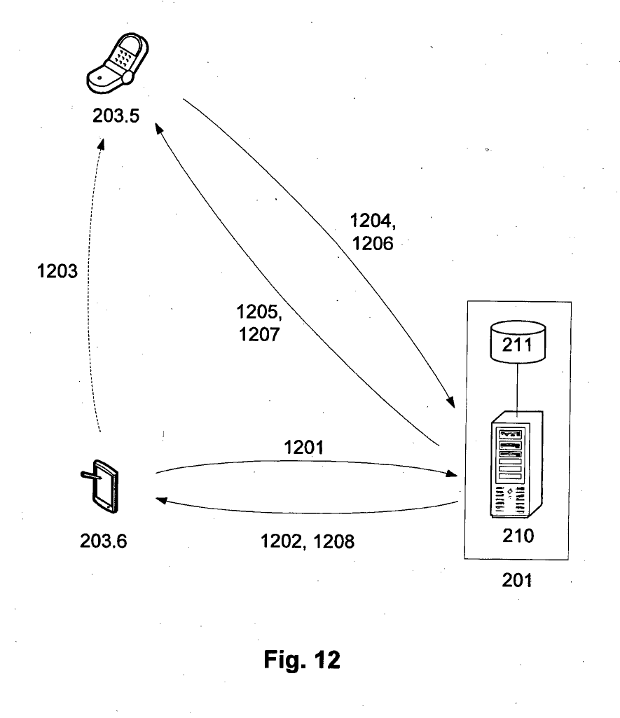

FIG. 12 shows an example apparatus configuration for making a payment from a payer to a payee, similar to the example method described above with reference to FIGS. 6A to 6C.

The payer operates a payer end station 203.5 and the payee operates a payee end station 203.6. In this case both of the end stations 203.5, 203.6 are mobile devices, which run the payment service provider's application software. In this case the payer end station 203.5 is a smart phone and the payee end station 203.6 is a tablet computer, although it will be appreciated that any mobile device having suitable communications capabilities may be used. The payment service provider operates a payment processing station 201.

At 1201 the payee end station 203.6 issues a payment request to the payment processing station 201. In response, the payment processing station generates a transaction code and payment details and supplies the transaction code to the payee end station 203.6 at 1202.

The payee end station 203.6 then presents the transaction code to the payer. As discussed in the above examples, the payer may obtain the transaction code in numerous ways, but in this case it is assumed that the payee end station 203.6 generates a barcode encoding the transaction code and displays this on a display of the payee end station 203.6, such that the barcode can be scanned by the payer end station 203.5. The scanning of the barcode is indicated at 1203.

The payment service provider's application on the payer end station 203.5 then decodes the barcode to obtain the transaction code, which is then transferred to the payment processing station along with a request for payment details at 1204. Payment details are returned to the payer end station 203.5 at 1205.

The payer then uses the payer end station 203.5 to select an account for the payment, enter authentication information, and authorise the payment, and the relevant information is provided to the payment processing station 201 at 1206, to allow the payment to proceed.

With the transaction now authorised by the payer, the payment service provider then causes the transfer of funds. After determining the result of the transfer, a notification is sent to the payer end station 203.5 at 1207. The payment service provider also provides notification of the transfer result to the payee at 1208.

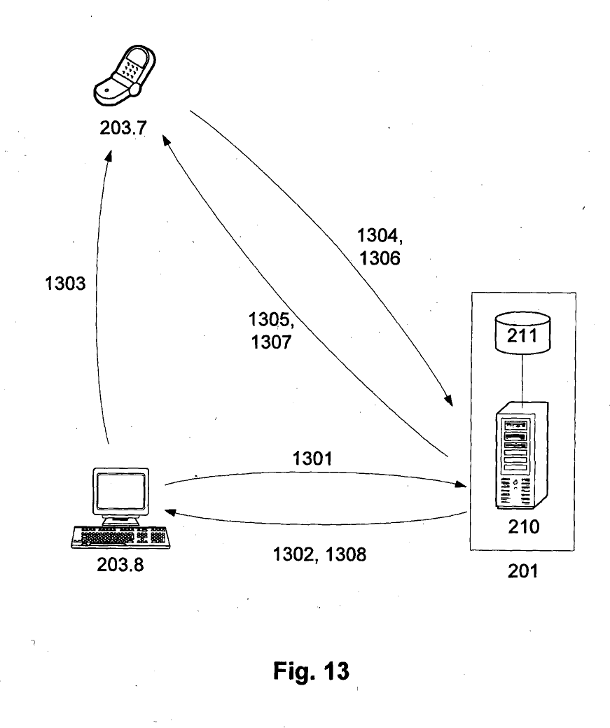

FIG. 13 shows an example apparatus configuration for making a point of sale payment from a customer to a merchant, similar to the example method described above with reference to FIGS. 7A to 7C.

The customer operates a customer end station 203.7 in the form of a mobile device, and the merchant operates a point of sale end station 203.8, such as a computer connected to a cash register or the like. The payment service provider operates a payment processing station 201.

The customer selects products for purchase in the merchant's store and takes these to the merchant's checkout where the purchase details are entered into the point of sale end station 203.8. The merchant will typically inform the customer of the total price for payment, and in this case the merchant is informed by the customer that they wish to pay using their the payment service provider's application software on the customer end station 203.7 (the customer's mobile device).

At 1301 the point of sale end station 203.8 issues a payment request to the payment processing station 201. In response, the payment processing station generates a transaction code and payment details and supplies the transaction code to the point of sale end station 203.8 at 1302.

The point of sale end station 203.8 then provides the transaction code to the customer. In this case it is assumed that the customer obtains the transaction code using wireless communications between the customer end station 203.7 and the point of sale end station 203.8, at 1303. For example, the transaction code may be transmitted using Near Field Communication (NFC).

In any event, the payment service provider's application on the customer end station 203.7 thus obtains the transaction code, which is then transferred to the payment processing station along with a request for payment details at 1304. Payment details are returned to the customer end station 203.7 at 1305.

The customer then uses the customer end station 203.7 to select an account for the payment, enter authentication information, and authorise the payment, and the relevant information is provided to the payment processing station 201 at 1306, to allow the payment to proceed.

With the transaction now authorised by the customer, the payment service provider then causes the transfer of funds. After determining the result of the transfer, a notification is sent to the customer end station 203.7 at 1307. The payment service provider also provides notification of the transfer result to the merchant's point of sale end station 203.8 at 1308.

The merchant can then confirm to the customer that payment has indeed been received and that the products have been paid for and can be taken by the customer.

Accordingly, the above described processes allow transactions to be performed, without requiring a payer to enter payment information, which is instead provided by the payee, to the payment processing station. The payment processing station then generates a transaction code, which is used to track each transaction, and provide payment details to the payer end station, either directly, or via the payer's financial institution. The payer is then authenticated in some manner, allowing the payer's financial institution, or the payment processing station, to confirm the identity of the payer, and then perform the transaction on that basis.

The above described processes therefore significantly simplify payments, in particular reducing the amount of information that needs to provided by the payer, which in turn reduces the likelihood of information being entered incorrectly. Furthermore, the payer need only authenticate themselves with either the payment processing station, or their own financial institution, meaning that information such as the payer's credit card details need never be provided to the payee. This in turn helps further enhance security of the system, allowing payer's to make payments, without disclosing their credit card, bank account details, or the like.

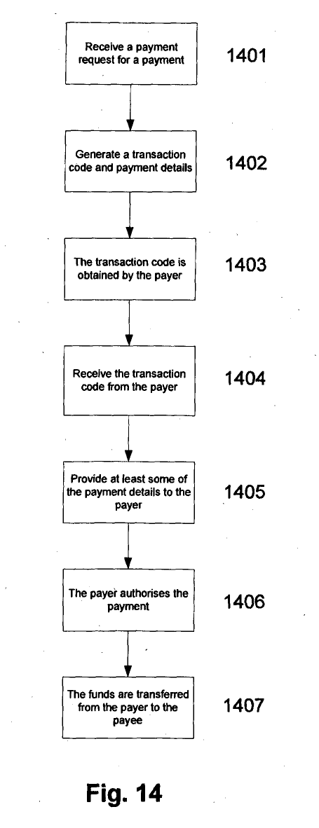

Other aspects of the payment method will now be described with reference to FIG. 14, which sets out a further broad example of a method for performing a payment from the payer to the payee.

In this example, the method begins at step 1401 in which a payment request for a payment is received. Typically, the payment request will be received by a payment service provider from a payee, although the payment request may be received indirectly from its source, such as by being transferred to the payment service provider via a financial institution of the payee. However, this is not essential and in some cases the payment request may be received by the financial institution of the payee.

The payment request is typically generated in response to the payee requesting funds from the payer, and may be of a similar form as described in previous examples. The payment request may be generated in different locations depending on the particular implementation of the method. For example, the payment request may be generated in a payee station operated by the payee, using an online merchant website operated on behalf of the payee, or the financial institution of the payee.

The payment request will usually include information regarding the payment, such as the payment amount and an indication of the payee, although it will be appreciated that a range of information may be provided in the payment request as discussed in previous examples.

In step 1402, a transaction code and payment details are generated using the payment request. The transaction code not only allows the payment to be identified, but can also be used to provide a flexible means of allowing the payer to receive payment details to allow the payment to be authorised. Whilst transaction code will be associated with the payment request and the generated payment details, its form is not particularly limited. Nevertheless, it is noted that preferred forms of the transaction code have been provided in earlier examples.

The payment details will typically be generated to include the types of details regarding the payment that a payer may wish to review before authorising the payment. Usually this will at least include a payment amount and an indication of the payee, although further details may be included such as identification of the payee's account into which the payment is to be made, a payee reference for the payment, conditions on how the payment can be made and details of products associated with the payment.

The transaction code and the payment details may be generated by a payment service provider but in some cases the transaction code and the payment details may be generated by the financial institution of the payee.

In any case, after the transaction code has been generated, the transaction code will be obtained by the payer as shown in step 1403. The transaction code may be obtained by the payer using a range of different techniques, as already discussed in detail above. Furthermore, the transaction code may by transferred via different parties, which may depend on the transfer technique used. For example, assuming the transaction code is generated by the payment service provider, this may in turn be supplied to any one of the payee, the financial institution of the payee, the payer, or the financial institution of the payer, and may be passed on through any one of those parties until it is ultimately obtained by the payer.

The payer only needs to obtain the transaction code to allow the payment to progress, and since the transaction code can be delivered to the payer in many ways this provides allows the payer with many choices in how to participate in the payment process. When the payer wishes to proceed with the payment, either immediately when the transaction code is received or at a later time of their choosing, the payer is able to use the transaction code to obtain the further payment details that the payer requires to authorise the payment.

In particular, the payee will typically provide the transaction code to their financial institution or to the payment service provider so that payment details can be retrieved for review. At step 1404, the transaction code is received from the payer, typically accompanied with a request for payment details associated with the transaction code. In some examples, the transaction code may be received via the financial institution of the payer.

Then, at step 1405, in response to receiving the transaction code, at least some of the payment details are provided to the payer. It will be appreciated that only a subset of the payment details may be required to allow the payment to be authorised by the payer, although this will usually include, at a minimum, the payment amount and an indication of the payee. In some cases, all of the payment details may be provided to the payer for review, but this is not essential.

Assuming the payer is satisfied with the payment details provided for review and wishes to finalise the payment, the payer authorises the payment at step 1406. This may involve the payer confirming that the payment is authorised using the payer station, and having an authorisation indication generated and provided to a party responsible for transferring the funds.

The funds can then be transferred from the payer to the payee as per step 1407, to thereby allow the payment to be performed. In some examples the transfer of funds may involve the payment service provider receiving the authorisation indication and then causing the funds to be transferred from the payer to the payee, such as by using registered account details for the payer and the payee. However, in other examples, the financial institution of the payer may receive the authorisation indication and arrange the transfer of funds from the payer's account directly, without the involvement of the payment service provider.

A notification of the result of the payment may optionally be provided to one or more of the payee, the financial institution of the payee, the payer, the financial institution of the payer. This may be used, for instance, to, confirm that purchased goods can be delivered or otherwise taken into the payer's possession, and/or to allow the generation of a receipt for the payment by the payee.

In any event, it will be appreciated that the above described example of the payment method uses the transaction code to allow the payment to be facilitated without requiring any personal information to be exchanged between the payee and the payer. Only the transaction code needs to be obtained by the payer to allow other payment details to be retrieved for the payment to be authorised. Furthermore, the authorisation and payment steps can be handled through communications between the payer and their financial institution, or a trusted payment service provider, without requiring any further involvement by the payee. Accordingly, the above example provides a flexible yet secure method for facilitating a range of different payment types.

It will be understood that the above example considers operation of the method from the perspective of one or more facilitators of the payment, such as the payment service provider. As far as the payer is concerned, many of these steps may occur as background processes. The above described method, from the perspective of the payer station operated by the payer, will broadly involve the steps of obtaining the transaction code, providing the transaction code to the payment service provider, receiving at least some of the payment details associated with the transaction code, displaying the payment details for review, receiving an authorisation from the payer to make the payment, and generating an authorisation indication for causing the funds to be transferred from the payer to the payee to thereby perform the payment.

As discussed above, financial institutions, including banks or the like, may play a role in the payment method. For instance, a financial institution may handle the authentication of the payer's identity and the authorisation for the payment to be made. In further examples, financial institutions may be more directly involved in the payment process by acting as an intermediary party between the payee or payer and the payment service provider. This can not only facilitate the aforementioned authentication and authorisation functions, but can allow the payee and the payer to only need to interface with their financial institution when requesting or making a payment.

Accordingly, functionality for handling payments in accordance with the above described processes may be integrated into existing application software or web interfaces provided by banks and other financial institutions for their customers to perform other banking tasks. Thus the payment process can be used by customers of participating financial institutions as part of their everyday banking. The financial institutions will then have the flexibility to implement the payment method to suit their particular requirements and/or to tailor the implementation to individual customer's needs.

This can also remove the need for customers to access separate application software or web interfaces for interfacing with the payment service provider. Research has indicated that banking customers often feel more comfortable transacting within their own bank's trusted environment, and are increasingly cautious of sharing confidential information with third parties. Thus, having the bank act as an intermediary may improve adoption rates for customers that may otherwise be wary of setting up a new account with a third party payment service provider in order to use the payment process. The payment service provider can still facilitate the actual transfer of funds, but in the background behind known and trusted banking interfaces.

In general terms, in examples where the bank or another financial institution acts as an intermediary party between customers and the payment service provider, a payee might initiate the payment method by requesting funds through their usual banking interface, and the payment request will then be transferred to the payment service provider as a background process. The transaction code for the payment request can then be returned to the payee via the payee's bank, so that the payee can then provide the transaction code to the payer to allow the payment to be made.

Once transaction code has been received at the payee station, the payee will then be able to provide the transaction code to the payer in any suitable manner. As discussed above, the payer may receive the transaction code using a range of methods and technologies for transferring data between two users. It should be noted that the transaction code may be shared between the payee and the payer directly, or through communications interfaces between the payee station and the payer station, or even between the respective banks of the payee and the payer. Accordingly, the transaction code may be transferred using any suitable mutually available communications technologies including Near Field Communications (NFC) Dual-Tone Multi-frequency Signalling (DTMF), Short Message Service (SMS), Email, Instant Messaging (IM) or the like. Alternatively, the transaction code may be manually input into the payer station by the payer.

In any event, the payer station will typically obtain the transaction code in some manner, and following this, the payer can interface with their own bank to complete the payment, generally without requiring any further involvement by the payee. The transaction code will be provided to the payer's bank which will in turn communicate with the payment service provider in the background to retrieve payment details to allow the payer to review these details and authorise the payment through their usual banking interface. The payer's bank can also verify the payment as it sees fit before allowing the payment to proceed, such as by screening for potentially fraudulent payment requests. The payer's bank can then communicate with the payment service provider once again to confirm that the funds can be transferred.

When the transfer has been successful, the payment service provider will confirm this to the banks and the payee and payer may then receive notifications from their respective banks.

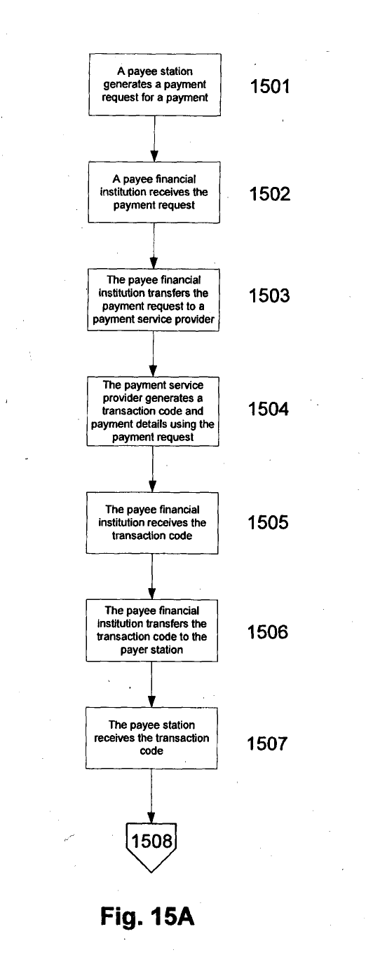

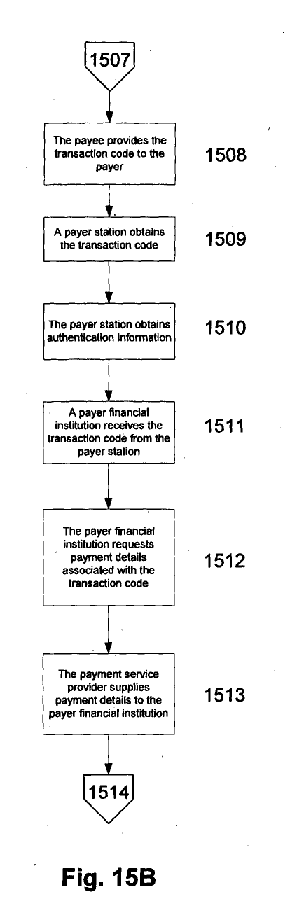

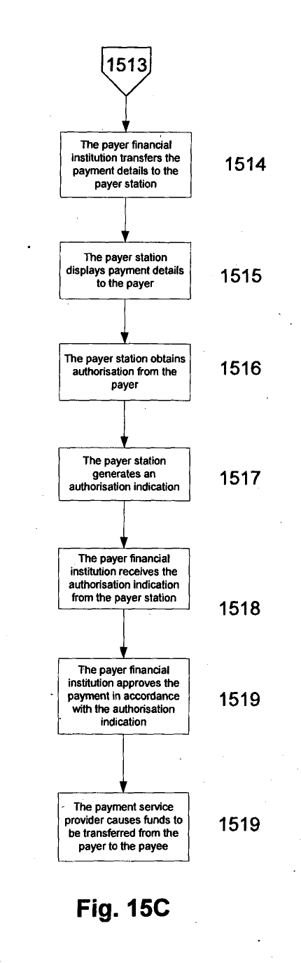

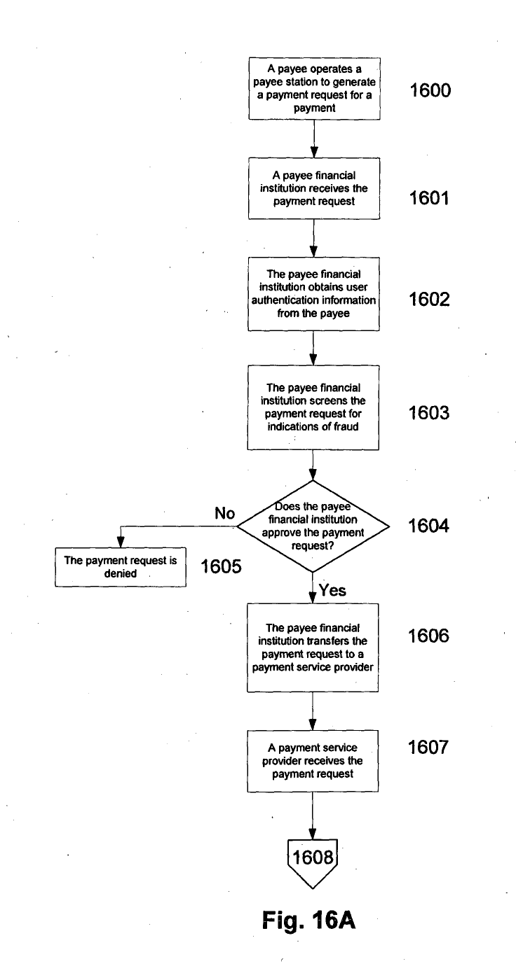

An example of such a process involving financial institutions as intermediary parties will now be described with reference to FIGS. 15A to 15C. This process assumes that the payee operates a payee station and interfaces with a payee financial institution, with whom they hold at least one account, and that the payer similarly operates a payer station and interfaces with a payer financial institution.

At step 1501, a payee station generates a payment request for a payment, typically in response to a payee operating the payee station indicating that they wish to generate a request using application software or a web interface provided by the payee financial institution on the payee station. The payee financial institution receives the payment request at step 1502, for example via internet communications from the payee station to a payee financial institution station.

At step 1503, the payee financial institution transfers the payment request to the payment service provider, typically via a backend interface to the payment service provider. The payee will not necessarily be aware of such background communications and from their perspective they are only interfacing with the payee financial institution through its application software or web interface.

At step 1504, the payment service provider generates a transaction code and payment details using the payment request in the usual manner as described above. The payee financial institution receives the transaction code at step 1505 and transfers this to the payer station at step 1506, where it is received at step 1507. The payee is then able to provide the transaction code to the payer using any suitable means at step 1508.

However, it will be appreciated that steps 1506, 1507 and 1508 are not essential, such that the payer does not need to receive the transaction code via the payee station and payee financial institution. In alternative implementations, the payment service provider may provide the transaction code directly to any one of the payee station, the payer station, or the payer financial institution. In any case, the payer will ultimately obtain the transaction code.

In view of the above, it will be appreciated that the financial institution of the payee may participate in the payment method by facilitating the provision of the transaction code in response to a payee's request for a payment. In short, the financial institution receives the payment request, provides the payment request to the payment service provider and optionally receives the transaction code generated by the payment service provider and provides the transaction code to the payee.

The payment method will then transition to steps performed in connection with the payer's authorisation of the requested payment and the actual transfer of funds, and the payee will generally have no active involvement in these steps. It is also noted that these steps do not need to proceed immediately after the transaction code being obtained by the payer, as, the payer may have flexibility to finalise the payment later at a more convenient time.

At step 1509 the transaction code is obtained by the payer station. This does not necessarily require the payer to enter the transaction code manually, as it may be transferred directly to the payer station depending on the technique used to provide the transaction code to the payer. The payer station may also obtain authentication information from the payer at step 1510, as required to verify the payer's identity and thus takes steps to ensure the payer station is not being operated fraudulently.

The payer financial institution receives the transaction code from the payer station at step 1511, and the payer financial institution subsequently requests payment details associated with the transaction code from the payment service provider at step 1512. In response, at step 1513 the payment service provider supplies the payment details associated with the transaction code to the payer financial institution, which is then transferred to the payer station at step 1514.

At step 1515 the payer station displays payment details to the payer to thereby allow the payer to review the payment details and authorise the payment. Typically this will involve displaying the payment amount to allow the payer to confirm the amount, along with at least an indication of the payee. Further payment details may be displayed including an indication of the reason for the payment, or conditions of the payment.

At step 1516 the payer station obtains authorisation from the payer to make the payment in accordance with the payment details. In response, the payer station generates an authorisation indication at step 1517 which are provided to the payer financial institution at step 1518.

The payer financial institution then has an opportunity to approve the payment in accordance with the authorisation indication at step 1519. At this stage, the payer financial institution may conduct further final checks and screening activities before allowing the payment to be completed. Assuming the financial institution has not identified any reason to decline the payment, the payment service provider causes funds to be transferred from the payer to the payee at step 1520, after which the payee and payer may be notified of successful payment.

As mentioned previously, in some examples the payer financial institution may transfer funds from the payer's account directly, without requiring further involvement of the payment service provider. In one particular implementation, the actual transfer of funds may be facilitated by having the payment service provider supply account details for the payee to the payer financial institution, and then having the payer financial institution cause the required funds to be transferred, from a selected account held by the payer with the payer financial institution, to the payee's account using the received account details.

It will be appreciated that the payer can select the account from which the payment is to be made through the financial institution directly, without requiring the payment service provider to have any knowledge of the accounts that the payer has available for making payments. Furthermore, under this arrangement, the payment service provider does not need to receive any account details for the payer's account that is selected for the payment.

In the above example, the account details for the payee may be stored by the payment service provider as part of registered details for the payee, or alternatively these payee account details may be supplied to the payment service provider at an appropriate stage in the payment process. For example, the payee account details may be supplied to the payment service provider along with the payment request for the payment, and in some examples these payee account details may be supplied by the payee financial institution.

In any event, the payment service provider is able to provide the account details for the payee to the payer financial institution at an appropriate stage in the payment process. It may be convenient for the account details for the payee to be provided along with the payment details at step 1513, although it will be appreciated that the account details will not necessarily be relayed to the payer station at step 1514. However, the account details for the payee may be provided at other stages in the process, such as following authorisation by the payer.

Thus, in summary, the financial institution of the payer is involved in receiving the transaction code from the payer, providing the transaction code to the payment service provider, receiving at least some of the payment details associated with the transaction code, providing the payment details to the payer, and receiving an authorisation from the payer to make the payment. It will be noted that, as per previous examples, there is no need for personal details of the payer, such as account details, to be provided to the payee or the payee financial institution to allow the payment to proceed.

In view of the above examples, it will be appreciated that implementing the payment method with financial institutions acting as an intermediary interface between the payee/payer and the payment service provider allows the financial institutions to maintain control over the payment method. Furthermore, all communications between the payee/payer end users and the payment service provider may be made via the financial institutions, such that there is no need for any direct interaction between end users of the payment method and the payment service provider.

This arrangement provides the payee financial institution with the ability to monitor payment requests and decline requests before a transaction code is generated or at any other later time in the payment process. Similarly this provides the payer financial institution with the ability to prevent suspicious payment from being completed or to prevent payment details associated with a transaction code from being forwarded to the customer if these do not pass review.

Accordingly, further detailed examples illustrating other potential operations which may be performed by the respective financial institutions and the payment service provider as the above payment method is carried out will now be described.

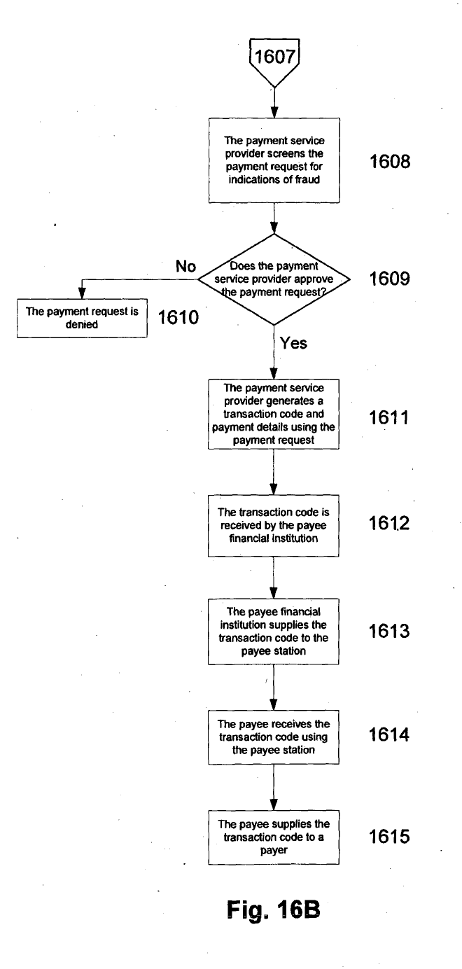

An example process for generating a payment request and associated transaction code, including screening of the payment request by the payee financial institution and the payment service provider will now be outlined with reference to FIGS. 16A and 16B.

At step 1600 the payee operates a payee station to generate a payment request for a payment, and the payee financial institution receives the payment request at step 1601 in the manner discussed above.

At step 1602 the payee financial institution obtains user authentication information from the payee to allow the payee's identity to be verified before taking any further action on the payment request. Then, assuming payee verification has been passed, at step 1603 the payee financial institution screens the payment request for indications that the payment request may be fraudulent.

If the payment request is suspected of being fraudulent at step 1604 the payee financial institution may disapprove of the payment request it may be denied at step 1605. However, if the payment request is approved by the payee financial institution the payment request will be allowed to proceed, in which case the payee financial institution transfers the payment request to the payment service provider at step 1606.

At step 1607 the payment service provider receives the payment request, and also has the opportunity to conduct additional fraud screening at step 1608. If the payment service provider does not approve of the payment request at step 1609 it may be denied at step 1610, but in the event the payment request is approved at step 1609, the payment service provider will continue the process by generating a transaction code and associated payment details using the payment request at step 1611. Alternatively, the transaction code may be generated prior to fraud screening and then a record of fraudulent activity can be tracked by the payment service provider with reference to the transaction code even if this is not to be used for a payment.

In this example, for the purpose of illustrating the potential involvement of the payee financial institution, it is assumed that the payee will be providing the transaction code to the payer after this is received from the payee financial institution. However, it should be understood that the transaction code may be obtained by the payer using any of the above mentioned techniques for transferring the transaction code.

At step 1612, the transaction code is received by the payee financial institution and this is supplied to the payee station at step 1613. The payee then receives the transaction code using the payee station at step 1614 and the payee supplies the transaction code to the payer at step 1615. Alternatively, however, the payee financial institution may be able to transfer the transaction code directly to the payer or to the payer's financial institution (which may be the same financial institution in some cases).

In any event, it will be appreciated that the above method allows the payment request to be blocked by the financial institution or the payment service provider and this can prevent fraudulent or other undesirable requests for payment from being presented to potential payers. This can help to ensure that attempted fraudulent activity is stopped before the payer is even aware of the fraudulent payment request.

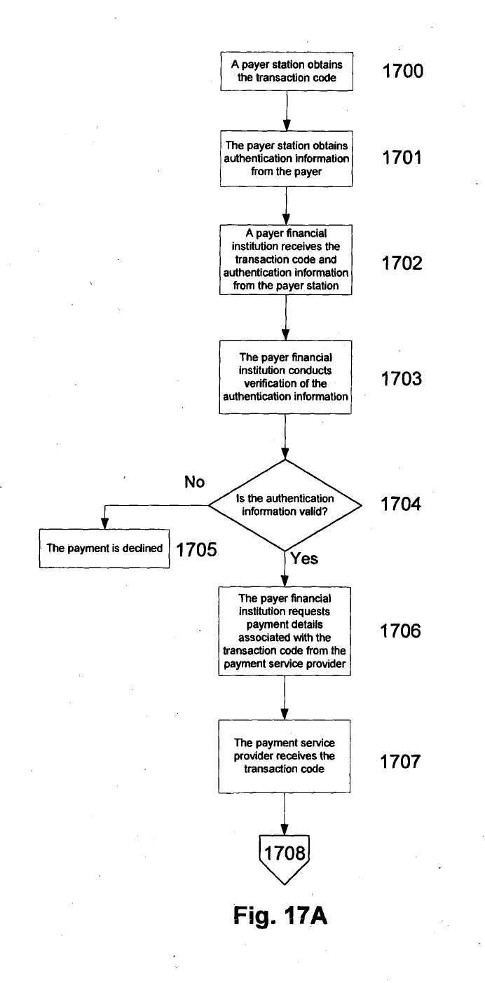

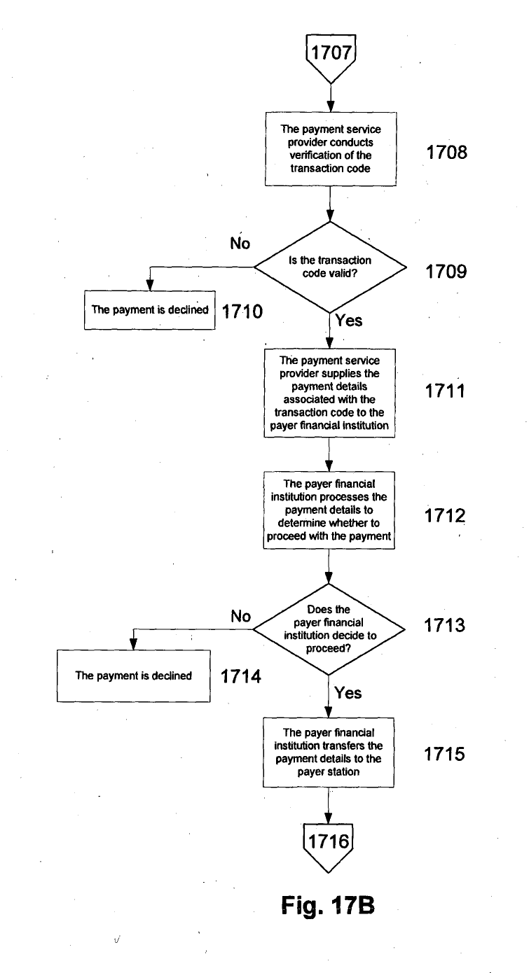

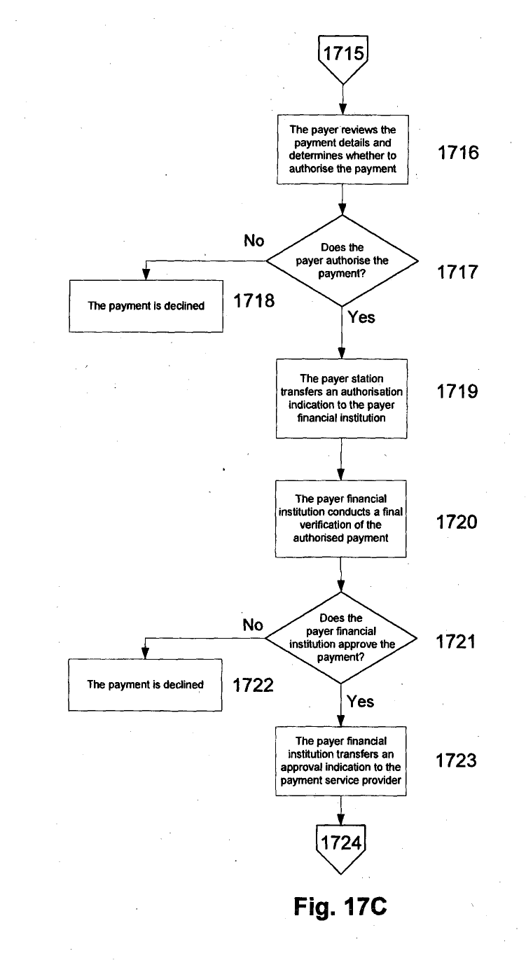

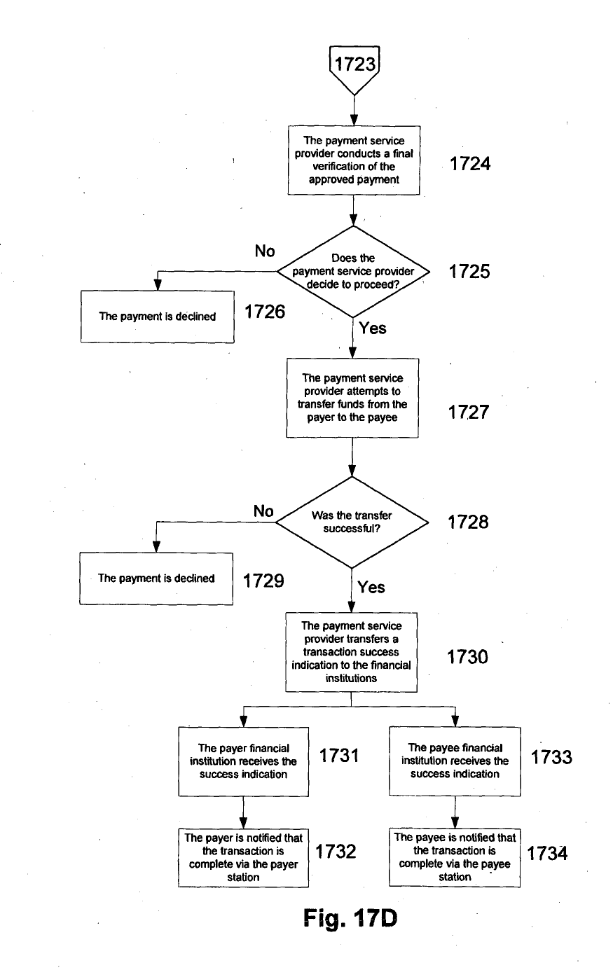

Similar screening and other checks may also be conducted as part of the authorisation of the payment by the payer, and further examples of this will now be expanded upon with reference to FIGS. 17A to 17D.

At step 1700 the payer station obtains the transaction code in any of the previously discussed manners. The payer station also obtains authentication information from the payer at step 1701. At step 1702 the payer financial institution then receives the transaction code and authentication information from the payer station, such as through the payer financial institution's application software or web interface accessed by the payer station.

At step 1703, the payer financial institution conducts verification of the authentication information. If the authentication information is deemed invalid at step 1704 then the payment may be declined at step 1705. However, if the authentication step is passed at step 1704 then the payer financial institution may proceed by requesting payment details associated with the transaction code from the payment service provider at step 1706.

At step 1707 the payment service provider receives the transaction code and the payment service provider may then conduct verification of the transaction code at step 1708, for instance by querying transaction code records and confirming whether that the received transaction code is valid and not expired. If the transaction code is found to be invalid the payment process may cease at step 1710, but if the transaction code is confirmed as valid at step 1709, the payment service provider will retrieve and supply the payment details associated with the transaction code to the payer financial institution at step 1711.

Having now received the payment details, the payer financial institution can then process the payment details to determine whether to proceed with the payment at step 1712. This processing may include the operation of a decision algorithm which analyses the payment details including the payment amount and other parameters of the payment. For instance, the payer financial institution may decide not to proceed if the payment request exceeds a predetermined daily payment limit for the payer's account.

In the event the payer financial institution decides not to proceed at step 1713 the payment may be declined at step 1714. However, if the payment details are acceptable the payer financial institution will proceed at step 1713 and the payer financial institution will transfer the payment details to the payer station at step 1715, where the payment details can be presented to the payer for authorisation.

At step 1716 the payer reviews the payment details and determines whether to authorise the payment. If the payment is not authorised at step 1717 then it will be declined at step 1718, but in the event of successful authorisation at step 1717 the payer station will then obtain the authorisation from the payer to make the payment and will transfer this to the payer financial institution at step 1719.

At step 1720 the payer financial institution will have the opportunity to conduct a final verification of the authorised payment before the transfer of funds is allowed to take place. If the payer financial institution does not provide final approval at step 1721 then the payment may be declined at step 1722. Otherwise, upon approval at step 1721 the payer financial institution generates an approval indication and transfers this to the payment service provider at step 1723.

The payment service provider may also conduct its own final verification of the approved payment at step 1724. This may include further screening for the indications of fraudulent activity. Whilst the payment request may have already been screened before the transaction code was generated, this screening may have taken place significantly earlier and it may the case that new evidence of fraudulent activity may have accumulated in the intervening time such that the payment service provider may desire to block the transfer of funds in view of the new evidence which was not available at the time of initial fraud screening for the payment request. Other verifications may also be performed to ensure the approved payment will proceed in accordance with the payment request.

In the event the payment service provider decides not to proceed at 1725, then the payment may be declined at step 1726. Otherwise, if the payment service provider cannot determine any reason to halt the payment at step 1725, then the payment service provider will proceed with the payment and attempt to cause the funds to be transferred from the payer to the payee at step 1727.

If the transfer is unsuccessful at step 1728 then the payment may be declined at step 1729. However, in the event of a successful transfer at step 1728 then the payment service provider generates a transaction success indication and transfers this to the respective financial institutions at step 1730.

Accordingly, the payer and payee can each be notified of the successful transfer. In particular, at step 1731 the payer financial institution receives the success indication and forwards this to the payer station so that the payer is notified that the transaction is complete at step 1732. Similarly, at step 1733 the payee financial receives the success indication and the payee is subsequently notified that the transaction is complete via the payee station at step 1734.

In other examples, similar processes involving the payee financial institution and the payer financial institution as an intermediate interface may also be applied to online purchase scenarios as discussed above with reference to FIGS. 5A to 5K, and other similar transactions.

In this regard, an online merchant wishing to receive online payments may have their merchant website redirect a customer to a payment gateway to allow payment to be completed for on online purchase. In particular, the payment gateway may facilitate the payment request on behalf of the merchant and also handle notifications to the merchant's billing system when the payment has ultimately been made by the customer.

The payment gateway may be hosted by the merchant's financial institution and thus operate under the financial institution's own branding and policies and therefore may increase the customer's confidence in completing the payment. In some examples, the payment gateway, may be provided and maintained by the payment service provider despite being hosted by the merchant's financial institution. Accordingly, the payment gateway functionality may be supplied by the payment service provider as a white label gateway to allow financial institutions to host a payment gateway compatible with the payment service provider's processes whilst also allowing the financial institutions to modify the interface for consistent look and feel compared to their existing interfaces. Although the payment gateway may be provided by the payment service provider, it may be hosted and operated by the financial institution independently of the payment service provider and the payment processing station responsible for facilitating the actual transfer of funds.

Even when a payment gateway is used by an online merchant, all payment requests may still be routed through the merchant's payee financial institution's own systems to allow screening of the payment request as discussed above. Thus payment requests initiated via the payment gateway may be cancelled by the merchant's payee financial institution at any point in the event of suspected fraud, or the like.

As such the involvement of the payment gateway in a payment process may be limited to simply providing a familiar customer interface for initiating the generation of a payment request and providing a received transaction code to the customer, thus allowing the payment to be made outside of the hosted payment gateway environment in any manlier desired by the customer, using any of the methods described above. The payment gateway may also optionally notify the customer of a successful payment, and thus confirm to the customer that the transaction is completed. The customer does not need to provide any personal information such as bank account details through the hosted payment gateway, and transactional details of the particular transfer of funds do not need to be routed through the payment gateway.

Such a hosted payment gateway may also facilitate batch requests, allowing multiple payments to be initiated with reduced effort. For example, this may particularly useful when a service provider needs to obtain transaction codes for a large quantity of periodic invoices. The hosted payment gateway may thus allow multiple payment requests to be generated in a batch operation which in turn can allow multiple transaction codes to be returned by the payment service provider. In such cases the payment gateway may also provide application programming interfaces (APIs) for allowing batch uploads of payment requests.

It will be appreciated that the principle of preventing the exchange of sensitive personal information and payment details between customers using the payment method provides a fundamental level of security against fraudulent use of that information. Furthermore, the example processes discussed above include the potential for fraud screening by the financial institutions and/or the payment service provider. Further details of the implementation of fraud prevention measures will now be discussed.

In the event that payment requests and transactions are facilitated with financial institutions acting as an intermediary party, this allows the financial institutions on each side of the transaction to integrate their own existing risk control measures and monitoring solutions.

The payments service provider can also utilise sophisticated fraud detection and monitoring methodologies which can work alongside the financial institution's solutions. For example, after receipt of a payment request or following the generation of the transaction code each request may pass through a comprehensive list of filters and a scoring model may be applied with the ability to both flag and cancel payments that exceed scoring thresholds.

Accordingly, this provides an advantage over traditional payment models in that the payment service provider is able to stop a payment prior to its completion.

Some specific examples of fraud indicators are as follows. Matching between the payment amount and other parameters of the payment request or information embedded in the transaction code may be performed, and this may also allow detection of code substitution or alteration. Location checking may be performed such as by comparing a network IP address location and an actual location detected by a mobile device (e.g. by using GPS technology). Unusual fluctuations in payment requests by a payee, such as spikes or drops in the value and/or volume of payment requests, may also be indicative of fraudulent activity. Regional filtering may also be used.

It will also be appreciated that advanced authentication methods may also be used to provide additional assurance over use of the payment method via mobile devices. Two-factor authentication may be conducted, and additional authentication methods may be introduced for large value transaction, for example. Voice recordings or biometric information such as fingerprints may also be used to verify a user's identity and provide an additional level of protection against unauthorised or fraudulent use.

Persons skilled in the art will appreciate that numerous variations and modifications will become apparent. All such variations and modifications which become apparent to persons skilled in the art, should be considered to fall within the spirit and scope that the invention broadly appearing before described.

1. A method for performing a payment from a payer to a payee, wherein the method includes:
a) receiving a payment request for the payment, the payment request being generated in response to the payee requesting funds from the payer;
b) generating a transaction code and payment details using the payment request, the transaction code being obtained by the payer;
c) receiving the transaction code from the payer; and,
d) in response to receiving the transaction code, providing at least some of the payment details to the payer including a payment amount and an indication of the payee, thereby allowing the payer to authorise the payment.

2. A method according to claim 1, wherein the method includes receiving the payment request from at least one of:
a) the payee; and,
b) a financial institution of the payee.

3. A method according to claim 1, wherein the method includes providing the transaction code to at least one of:
a) the payee;
b) the financial institution of the payee;
c) the payer; and,
d) a financial institution of the payer.

4. A method according to claim 1, wherein the method includes receiving the transaction code from at least one of:
a) the payer; and,
b) the financial institution of the payer.

5. A method according to claim 1, wherein the method includes:
a) receiving an authorisation indication, the authorisation indication being generated in response to authorisation of the payment by the payer; and,
b) in response to the authorisation indication, causing the funds to be transferred from the payer to the payee to thereby perform the payment.

6. A method according to claim 5, wherein the method includes causing the funds to be transferred from the payer to the payee using registered account details for the payer and the payee.

7. A method according claim 5, wherein the method includes providing a notification of results of the payment to at least one of:
a) the payee;
b) the financial institution of the payee;
c) the payer; and,
d) the financial institution of the payer.

8. A method according to claim 1, wherein the method includes:
a) receiving the transaction code from the financial institution of the payer; and,
b) providing the payment details to the financial institution of the payer, thereby allowing the payer to authorise the payment via the financial institution of the payer.

9. A method according to claim 1, wherein the method includes screening, for an indication of fraud, at least one of:
a) the payment request;
b) the transaction code; and,
c) the payment details.

10. A method according to claim 1, wherein the method includes verifying the transaction code before providing the at least some of the payment details.

11. A method according to claim 1, wherein the payment request includes payment request parameters supplied by the payee, at least some of the payment details being generated using the payment request parameters.

12. A method according to claim 11, wherein the payment request parameters include at least one of:
a) the payment amount;
b) the indication of the payee;
c) identification of the payee's account into which the payment is to be made;
d) a payee reference for the payment;
e) conditions on how the payment can be made; and,
f) details of products associated with the payment.

13. A method according to claim 12, wherein the conditions include at least one of:
a) whether the payment can be made in parts;
b) whether the payment can be overpaid;
c) a duration of time within which payment must be made; and,
d) whether the payment is a recurring payment.

14. A method according to claim 1, wherein the transaction code includes a string of a plurality of alphanumeric characters.

15. A method according to claim 4, wherein the transaction code is generated using a base 36 numeral system.

16. A method according to claim 14, wherein at least some predetermined character positions within the transaction code are used to encode information regarding at least one of the payee and the payment.

17. A method according to claim 1, wherein the transaction code is obtained by a plurality of payers, and the method includes:
a) receiving the transaction code from each of the plurality of payers;
b) providing the at least some of the payment details to the plurality of payers; and,
c) receiving authorisation for a respective portion of the payment from each of the plurality of payers, such that the total amount of the portions is equal to or greater than the amount of the payment requested by the payee.

18. A method according to claim 1, wherein the method includes communicating with the payer via the financial institution of the payer.

19. A method for providing a transaction code for use in performing a payment from a payer to a payee, wherein the method includes a financial institution of the payee:
a) receiving a payment request for the payment from the payee, the payment request being generated in response to the payee requesting funds from the payer;
b) providing the payment request to a payment service provider to allow a transaction code and payment details to be generated using the payment request;
c) receiving the transaction code from the payment service provider; and,
d) providing the transaction code to the payee.

20. A method according to claim 19, wherein the method includes the financial institution of the payee screening the payment request for an indication of fraud.

21. A method according to claim 19, wherein the method includes the financial institution of the payee:
a) obtaining an authentication information from the payee; and,
b) verifying the authentication information before providing the payment request to the payment service provider.

22. A method for receiving authorisation for use in performing a payment from a payer to a payee, wherein the method includes a financial institution of the payer:
a) receiving a transaction code from the payer, the transaction code being associated with payment details for the payment;
b) providing the transaction code to a payment service provider;
c) receiving at least some of the payment details associated with the transaction code from the payment service provider, the at least some of the payment details including a payment amount and an indication of the payee;
d) providing the at least some of the payment details to the payer; and,
e) receiving an authorisation from the payer to make the payment in accordance with the at least some of the payment details.

23. A method according to claim 22, wherein the method includes the financial institution of the payer screening the at least some of the payment details for an indication of fraud.

24. A method according to claim 22, wherein the method includes the financial institution of the payer:
a) obtaining authentication information from the payer; and,
b) verifying the authentication information.

25. A method according to claim 22, wherein the method includes the financial institution of the payer:
a) in response to authorisation of the payment by the payer, generating an authorisation indication; and,
b) providing the authorisation indication to the payment service provider to thereby allow the payment service provider to cause the funds to be transferred from the payer to the payee to thereby perform the payment.

26. A method according to claim 22, wherein the method includes the financial institution of the payer, in response to receiving the authorisation, causing the funds to be transferred from the payer to the payee to thereby perform the payment.

27. A method for performing a payment from a payer to a payee, wherein the method includes, at a payer station operated by the payer:
a) obtaining a transaction code, the transaction code being associated with payment details for the payment;
b) providing the transaction code to a payment service provider;
c) receiving at least some of the payment details associated with the transaction code from the payment service provider, the at least some of the payment details including a payment amount and an indication of the payee;
d) displaying the at least some of the payment details;
e) receiving an authorisation from the payer to make the payment in accordance with the at least some of the payment details; and,
f) generating an authorisation indication for causing the funds to be transferred from the payer to the payee to thereby perform the payment.

28. A method according to claim 27, wherein the authorisation indication is provided to at least one of:
a) the payment service provider; and,
b) a financial institution of the payer.

29. A method according to claim 27, wherein the method includes the payer station receiving authentication information for allowing an identity of the payer to be verified before the authorisation.

30. A method according to claim 29, wherein the authentication information is provided to at least one of:
a) the payment service provider; and,
b) a financial institution of the payer.

31. A method according to claim 27, wherein the transaction code is obtained by the payer station using at least one of:
a) short messaging service (SMS);
b) instant messaging (IM)
c) email;
d) dual-tone multi-frequency signalling (DTMF);
e) wireless communication;
f) near field communication (NFC);
g) a barcode;
h) a QR code; and,
i) manual input by the payer.

32. A method for performing a payment from a payer operating a payer station to a payee operating a payee station, wherein the method includes:
a) at the payee station, generating a payment request for the payment
b) at a payment processing station,
i) receiving the payment request; and,
ii) generating a transaction code and payment details using the payment request;
c) at the payer station, obtaining the transaction code;
d) at the payment processing station:
i) receiving the transaction code from the payer station; and,
ii) providing at least some of the payment details to the payer station including a payment amount and an indication of the payee; and,
e) at the payer station:
i) receiving the at least some of the payment details; and,
ii) obtaining authorisation from the payer to make the payment in accordance with the at least some of the payment details.

33. A method according to claim 32, wherein the method includes:
a) at the payer station:
i) in response to the authorisation from e payer, generating an authorisation indication; and,
ii) providing the authorisation indication to the payment processing station; and,
b) at the payment processing station:
i) receiving the authorisation indication; and,
ii) in response to the authorisation indication, causing the funds to be transferred from the payer to the payee to thereby perform the payment.

34. A method according to claim 32, wherein the method includes the payment processing station receiving the payment request from at least one of:
a) the payee station; and,
b) a payee financial institution station.

35. A method according to claim 32, wherein the method includes the payment processing station providing the transaction code to at least one of:
a) the payee station;
b) the payee financial institution station;
c) the payer station; and,
d) a payer financial institution.

36. A method according to claim 32, wherein the method includes the payment processing station receiving the transaction code from at least one of:
a) the payer station; and,
b) the payer financial institution station.

37. A method according to claim 32, wherein the method includes, at a payer financial institution station:
a) receiving an authorisation indication from the payer station; and,
b) providing the authorisation indication to the payment processing station to thereby cause the funds to be transferred from the payer to the payee.

38. A method according to claim 32, wherein the method further includes having the payment request screened for indications of fraud by at least one of:
a) the payee station;
b) the payee financial institution; and,
c) the payment processing station.

39. A method according to claim 32, wherein the method further includes having at least some of the payment details screened for indications of fraud by at least one of:
a) the payer station;
b) the payer financial institution; and,
c) the payment processing station.

40. A method for performing a payment from a payer operating a payer station to a payee operating a payee station, wherein the method includes:
a) at the payee station;
i) generating a payment request for the payment; and,
ii) providing the payment request to a payee financial institution
b) at the payee financial institution station:
i) receiving the payment request; and,
ii) providing the payment request to a payment processing station;
c) at the payment processing station,
i) receiving the payment request; and,
ii) generating a transaction code and payment details using the payment request;
d) at the payer station:
i) obtaining the transaction code; and,
ii) providing the transaction code to the payer financial institution
e) at the payer financial institution station:
i) receiving the transaction code; and,
ii) providing the transaction code to a payment processing station;
f) at the payment processing station:
i) receiving the transaction code; and,
ii) providing at least some of the payment details to the payer financial institution including a payment amount and an indication of the payee;
g) at the payer financial institution station:
i) receiving the at least some of the payment details; and,
ii) providing the at least some of the payment details to the payer;
h) at the payer station:
i) receiving the at least some of the payment details; and,
ii) obtaining authorisation from the payer to make the payment in accordance with the at least some of the payment details; and,
i) in response to the authorisation, causing funds to be transferred from the payer to the payee to thereby perform the payment.

41. A method for performing a payment from a payer operating a payer station to a payee operating a payee station, wherein the method includes:
a) at the payee station, generating a payment request for the payment;
b) at the payer station:
i) obtaining a transaction code and payment details, the transaction code and payment details being generated using the payment request;
ii) obtaining authentication information;
iii) obtaining authorisation from the payer to make the payment in accordance with the payment details; and,
iv) generating an authorisation indication and authentication information; and,
c) at a payment processing station, in response to the authorisation indication and the authentication information, causing funds to be transferred from the payer to the payee to thereby perform the payment.

42. A method according to claim 41, wherein the method further includes, at the payment processing station:
a) receiving the payment request from the payee station; and,
b) generating the transaction code and the payment details using the payment request.

43. A method according to claim 41, wherein the method further includes, at the payee station, generating the transaction code and the payment details using the payment request.

44. A method according to claim 41, wherein the payment request includes payment request parameters supplied by the payee, at least some of the payment details being generated using the payment request parameters.

45. A method according to claim 44, wherein the payment request parameters include at least one of:
a) identification of the payee's account into which payment is to be made;
b) a payee reference for the payment;
c) an amount of funds to be paid;
d) conditions on how the payment can be made; and,
e) details of products associated with the payment.

46. A method according to claim 45, wherein the conditions include at least one of:
a) whether the payment can be made in parts;
b) whether the payment can be overpaid;
c) a duration of time within which payment must be made; and,
d) whether the payment is a recurring payment.

47. A method according to claim 41, wherein the method further includes:
a) at the payment processing station, associating payment details with the transaction code; and,
b) at the payer station:
i) obtaining the transaction code; and,
ii) obtaining, from the payment processing station, payment details associated with the transaction code and displaying at least some of the payment details to the payer for authorisation.

48. A method according to claim 41, wherein the transaction code includes a string of a plurality of alphanumeric characters.

49. A method according to claim 48, wherein the transaction code is generated using a base 36 numeral system.

50. A method according to claim 48, wherein at least some predetermined character positions within the transaction code are used to encode information regarding at least one of the payee and the payment.

51. A method according to claim 48, wherein a receipt number is generated after a payment has been performed, the receipt number including the transaction code for the payment.

52. A method according to claim 51, wherein the receipt number further includes an expandable portion of characters in addition to the characters of the transaction, the expandable portion being used in the event that a plurality of payments are made for the same transaction code.

53. A method according to claim 41, wherein the method is used to perform a payment for an online purchase of products from the payee by the payer, the method further including, at the payee station:
a) receiving, from a payer using the payer station to access a payee website hosted by the payee station, a selection of products for purchase;
b) generating the payment request for payment for the products;
c) transferring the payment request to the payment processing station;
d) receiving confirmation from the payment processing station once payment has been performed; and,
e) arranging delivery of the products to the payer.

54. A method according to claim 41, wherein the authentication information and authorisation indication are obtained by a financial institution station holding an account of the payer.

55. A method according to claim 54, wherein the method further includes:
a) at the financial institution station, receiving the transaction code and the payment details;
b) at the payer station, communicating with the financial institution station to provide authentication information and to authorise the payment associated with the transaction code, in accordance with the payment details; and,
c) at the payment processing station, receiving an authorisation indication from the financial institution and transferring funds from the payer to the payee to thereby perform the payment.

56. A method according to claim 41, wherein the method includes embedding the transaction code into a barcode that is provided to the payer, the payer station obtaining the transaction code by scanning and decoding the barcode.

57. A method according to claim 56, wherein the barcode is provided to the payer by at least one of:
a) printing the barcode onto an invoice;
b) displaying the barcode on the payee station;
c) displaying the barcode on the payer station; and,
d) printing the barcode onto an object.

58. A method according to claim 57, wherein the payer operates a first payer station and a second payer station, the second payer station being a mobile computing device, the barcode being displayed on a display of the first payer station and being scanned and decoded by the second payer station such that the transaction code is obtained by the second payer station.

59. A method according to claim 41, wherein the payer operates a first payer station and a second payer station, the second payer station being a mobile computing device, the method further including:
a) at the second payer station, providing a one time password to the payer; and,
b) at the first payer station, having the payer input the one time password to thereby obtain at least some of the authentication information.

60. A method according to claim 41, wherein, the payer station is a mobile computing device that operates application software for allowing secure communications with the payment processing station.

61. A method according to claim 60, wherein the method is used to perform a point of sale payment for a purchase of products from the payee by the payer, the method further including:
a) at the payee station:
i) generating the payment request for payment for products selected by the payer for purchase; and,
ii) providing the transaction code to the payer;
b) at the payer station:
i) obtaining the transaction code;
ii) obtaining authentication information and obtaining authorisation from the payer; and,
iii) providing an authorisation indication and authentication information to the payment processing station; and,
c) at the payee station:
i) receiving confirmation from the payment processing station once payment has been performed; and,
ii) providing confirmation to the payer that the products have been paid for.

62. A method according to claim 61, wherein the payment processing station provides the transaction code to the payer station.

63. A method according to claim 41, wherein each of the payee and the payer are account holders holding at least one account with a financial institution and having respective account details registered with the payment processing station.

64. A method according to claim 63, where the registration of an account holder's account includes:
a) at the payment processing station:
i) receiving a pairing request from an account holder; and,
ii) generating a pairing code and providing the pairing code to the account holder;
b) at the financial institution:
i) receiving the pairing code;
ii) communicating with the payment processing station to obtain verification of the pairing code; and,
iii) providing the account holder's account details to the payment processing station; and,
c) at the payment processing station, storing the account details to thereby register the account.

65. A method according to claim 41, wherein the method includes having a plurality of payers make portions of the payment such that the total amount of the portions is equal to or greater than the amount of the payment requested by the payee.

66. A method according to claim 65, wherein each of the plurality of payers operates a respective payer station, the method further including, at each payer station:
a) obtaining the transaction code and payment details;
b) receiving, from the payer, authorisation for making a specified portion of the payment associated with the transaction code;
c) transferring an authorisation indication to the payment processing station, to allow the payment processing station to cause funds to be transferred from the payer to the payee to thereby perform the portion of the payment; and,
d) receiving a receipt number for the portion of the payment.

67. A method according to claim 66, wherein the payment processing station provides a notification to the payee once the amount of the payment requested by the payee has been collectively paid by the plurality of payers.

68. A method according to claim 41, wherein the method includes the payment processing station authenticating the payer's identity before causing the funds to be transferred.

69. A method according to claim 68, wherein the authentication includes at least one of:
a) requiring entry of an authentication code by the payer at the payer station;
b) requiring that the payer station has a device identifier matching a registered device identifier; and,
c) requiring entry of a biometric identifier matching a registered biometric identifier.

70. A method for performing a payment from a payer operating a payer station to a payee operating a payee station, wherein the method includes, at a payment processing station:
a) receiving, from the payee station, a payment request for the payment;
b) generating a transaction code and payment details using the payment request; and,
c) in response to an authorisation indication and authentication information generated by the payer station, causing funds to be transferred from the payer to the payee to thereby perform the payment.

71. A method for performing a payment from a payer operating a payer station to a payee operating a payee station, wherein the method includes, at the payer station:
a) receiving a transaction code and payment details generated using a payment request, the payment request being generated by the payee station;
b) displaying the payment details;
c) in response to the displayed payment details, receiving authorisation and authentication information from the payer; and,
d) generating an authorisation indication and the authentication information for transfer to the payment processing station, to allow the payment processing station to cause funds to be transferred from the payer to the payee to thereby perform the payment.

72. Apparatus for performing a payment transaction from a payer to a payee, the apparatus including a payer station operated by the payer, a payee station operated by the payee, and a payment processing station operated by a payment service provider, wherein the apparatus is for:
a) at the payee station, generating a payment request for the payment;
b) at the payer station:
i) obtaining a transaction code and payment details, the transaction code and payment details being generated using the payment request;
ii) obtaining authentication information;
iii) obtaining authorisation from the payer to make the payment in accordance with the payment details; and,
iv) generating an authorisation indication and authentication information; and,
c) at a payment processing station, in response to the authorisation indication and the authentication information, causing funds to be transferred from the payer to the payee to thereby perform the payment.

73. Apparatus according to claim 72, wherein the payer station and payee station communicate with the payment processing station using a communications network.

74. (canceled)

75. Apparatus for performing a payment from a payer operating a payer station to a payee operating a payee station, the apparatus including a payment processing station in communication with the payer station and the payee station, wherein the payment processing station is for:
a) receiving, from the payee station, a payment request for the payment;
b) generating a transaction code and payment details using the payment request; and,
c) in response to an authorisation indication of authorisation from the payer to make the payment associated with the transaction code and authentication information generated by the payer station, causing funds to be transferred from the payer to the payee to thereby perform the payment.

76. Apparatus for performing a payment from a payer to a payee, the apparatus including a payer station operated by the payer, a payee station operated by the payee, and a payment processing station operated by a payment service provider, wherein the payer station is for:
a) receiving a transaction code any payment details generated using a payment request, the payment request being generated by the payee station;
b) displaying the payment details;
c) in response to the displayed payment details, receiving authorisation and authentication information from the payer; and,
d) generating an authorisation indication and the authentication information for transfer to the payment processing station, to allow the payment processing station to cause funds to be transferred from the payer to the payee to thereby perform the payment.
